(19) United States
(12) Patent Application Publication
(10) Pub. No.: US 2024/0415121 A1
(43) Pub. Date: Dec. 19, 2024

(54) METHOD FOR CONTROLLING UNDESIRABLE VEGETATION IN AN AQUATIC ENVIRONMENT

(71) Applicant: BASF AGRO B.V., Amhem (NL)

(72) Inventors: Walid A. Al-Akhdar, Durham, NC (US); Heath Reeves, Durham (NC)

(21) Appl. No.: 18/718,870

(22) PCT Filed: Dec. 5, 2022
(86) PCT No.: PCT/EP2022/084396

§ 371 Date: Jun. 12, 2024

(30) Foreign Application Priority Data
Dec. 16, 2021 (EP) 21215119.5

(51) Int. Cl. A01N 43/54; A01P 13/00

(52) U.S. Cl. CPC A01N 43/54; A01P 13/00

(57) ABSTRACT

The present invention relates to a method for controlling undesirable vegetation in an aquatic environment in which a rice plant is growing. In the method of this invention, a herbicidally effective amount of a herbicide A or of a composition comprising the herbicide A is applied to the aquatic environment pre-emergence or early post-emergence of the undesirable vegetation and after germination of the rice seedlings wherein the herbicide A is selected from acetochlor, acifluorfen, alachlor, aminopyralid, bensulfuron, benzobicyclon, bicyclopyrone, bispyribac, butylate, carfentrazone, chlorimuron, chlorsulfuron, cinmethylin, clethodim, clodinafop, clomazone, clopyralid, cycloate, cyhalofop, 2,4-D, dicamba, diflufenzopyr, dimethenamid, dimethenamid-P, dithiopyr, EPTC, ethalfluralin, ethofumesate, fenoxaprop, fenoxaprop-P, florpyrauxifen, fluazifop, fluazifop-P, flufenacet, flumiclorac, flumioxazin, fluroxypyr, fluthiacet, fomesafen, halauxifen, halosulfuron, iodosulfuron, imazamox, imazapic, imazapyr, imazaquin, imazethapyr, isoxaflutole, lactofen, MCPA, mesosulfuron, mesotrione, metolachlor, S-metolachlor, metsulfuron, MSMA, nicoculfuron, orthosulfamuron, penoxsulam, pinoxaden, primisulfuron, propanil, propyzamide, pyrasulfotole, pyrithiobac, pyroxasulfone, pyroxulam, quinclorac, quizalofop, quizalofop-P, rimsulfuron, saflufenacil, sethoxydim, sulfentrazone, sulfosulfuron, tembotrione, tetflupyrolimet, thifensulfuron, thiobencarb, tiafenacil, tolpyralate, topramezone, triallate, triasulfuron, tribenuron, triclopyr, trifloxysulfuron, trifludimoxazin, trifluralin, triflusulfuron and agriculturally acceptable salts or derivatives thereof. The method is particularly suitable for weed control in flooded rice fields.

The present invention relates to a method for controlling undesirable vegetation in an aquatic environment in which a rice plant is growing. In the method of this invention, a herbicidally effective amount of a herbicide A or of a composition comprising the herbicide A is applied to the aquatic environment pre-emergence or early post-emergence of the undesirable vegetation and after germination of the rice seedlings wherein the herbicide A is selected from acetochlor, acifluorfen, alachlor, aminopyralid, bensulfuron, benzobicyclon, bicyclopyrone, bispyribac, butylate, carfentrazone, chlorimuron, chlorsulfuron, cinmethylin, clethodim, clodinafop, clomazone, clopyralid, cycloate, cyhalofop, 2,4-D, dicamba, diflufenzopyr, dimethenamid, dimethenamid-P, dithiopyr, EPTC, ethalfluralin, ethofumesate, fenoxaprop, fenoxaprop-P, florpyrauxifen, fluazifop, fluazifop-P, flufenacet, flumiclorac, flumioxazin, fluroxypyr, fluthiacet, fomesafen, halauxifen, halosulfuron, iodosulfuron, imazamox, imazapic, imazapyr, imazaquin, imazethapyr, isoxaflutole, lactofen, MCPA, mesosulfuron, mesotrione, metolachlor, S-metolachlor, metsulfuron, MSMA, nicosulfuron, orthosulfamuron, penoxsulam, pinoxaden, primisulfuron, propanil, propyzamide, pyrasulfotole, pyrithiobac, pyroxasulfone, pyroxsulam, quinclorac, quizalofop, quizalofop-P, rimsulfuron, saflufenacil, sethoxydim, sulfentrazone, sulfosulfuron, tembotrione, tetflupyrolimet, thifensulfuron, thiobencarb, tiafenacil, tolpyralate, topramezone, triallate, triasulfuron, tribenuron, triclopyr, trifloxysulfuron, trifludimoxazin, trifluralin, triflusulfuron and agriculturally acceptable salts or derivatives thereof. The method is particularly suitable for weed control in flooded rice fields.

### BACKGROUND OF THE INVENTION

Rice is the most important human food crop in the world, directly feeding more people than any other crop. Two rice species are important cereals for human nutrition: Oryza sativa L., the Asian rice, and O. glaberrima Steud., the African rice. O. sativa L. constitutes virtually all of the world's cultivated rice and is also grown in the United States, inter alia in the Central Valleys of California.

Weeds are a major challenge in rice production and can account to 59% yield loss with watergrasses (Echinochloa spp.) and up to 100% in dry-seeded systems in California (Brim-DeForest, W. B., Al-Khatib, A. and Fischer, A. J. (2017). Predicting yield losses in rice mixed-weed species infestations in California. Weed Science, 65, pp. 61-71). Major competitive watergrass species include barnyardgrass (Echinochloa crus-galli), early watergrass (Echinochloa oryzoides), late watergrass (Echinochloa phyllopogon) and Sprangletop (Leptochloa fusca).

Rice is a semi-aquatic crop that benefits from flooded soil conditions during part or all of the growing season. Rice production in the United States can be broadly categorized as either dry-seeded or water-seeded. In the dry-seeded system, rice is sown into a well-prepared seed bed with a grain drill or by broadcasting the seed and incorporating it with a disk or harrow. Moisture for seed germination is from irrigation or rainfall. Another method of planting by the dry-seeded system is to broadcast the seed by airplane into a flooded field, then promptly drain the water from the field. For the dry-seeded system, when the plants have reached sufficient size (four- to five-leaf stage), a shallow permanent flood of water 5 to 16 cm deep is applied to the field for the remainder of the crop season. Rice varieties are favorable that grow quickly as seedlings to compete with weeds and accelerate the application of a permanent flood that suppresses the growth of grassy weeds. Residual grass herbicides are also used to prevent the emergence of new weeds.

In the water-seeded system, rice seed is soaked for 12 to 36 hours to initiate germination, and the seed is broadcast by airplane into a flooded field. This is the predominant rice production system in California. Some herbicides are applied pre-emergence (applied to soil before flooding) and some applied at the date of seeding or early in the first few weeks of rice seedling growth. Controlling weeds at germination or when they are young reduces competition with the rice seedling, hastening the rice plant growth and canopy closure that helps suppress weeds. Weeds are also much easier to control when in the early stages of growth. Pre-emergence application have advantages to the grower in that they can be accomplished at the final stage of seedbed preparation by ground as opposed to an aerial application when the field is flooded. Aerial application of pesticides is subject to regulation and restriction due to potential drift or movement, and some rice herbicide materials cannot be applied by air in California. In some cases, the herbicides are not liquid sprays but granules that disperse in the flooded paddy to control the weeds. This is of great advantage to prevent drift or movement of the herbicide from the target field. Maintaining a permanent flood supports the control of grassy weeds, especially in combination with selective grass herbicides. The aquatic weeds (e.g., sedges and rushes), however are favored by the permanent flood. The water-seeded system lends itself to the water infrastructure, delivery to the fields, and management in California. The rice seedlings emerge through a shallow flood, or the water may be drained from the field for a short period of time to enhance seedling establishment. Lowering the water improves stand establishment by providing additional oxygen that enhances root growth and better anchoring the seedling against uprooting by wind and wave action. It also exposes weeds for contact herbicide applications. However, this promotes grassy weed growth, nitrogen loss, and increased water consumption and management. Herbicide use on rice can injure the rice plant and reduce plant growth, shorten the height, delay maturity and possibly reduce yield. Draining the field or lowering the water is used to lessen herbicide injury; however, this may not be possible because of water hold periods required for an herbicide, and water management and use efficiency. In recent years, due to environmental regulations, appearance of herbicide resistant weeds and phasing out of older herbicides, weed control in commercial rice production in California has become a primary production issue for growers.

The aforementioned herbicides A being selected from acetochlor, acifluorfen, alachlor, aminopyralid, bensulfuron, benzobicyclon, bicyclopyrone, bispyribac, butylate, carfentrazone, chlorimuron, chlorsulfuron, cinmethylin, clethodim, clodinafop, clomazone, clopyralid, cycloate, cyhalofop, 2,4-D, dicamba, diflufenzopyr, dimethenamid, dimethenamid-P, dithiopyr, EPTC, ethalfluralin, ethofumesate, fenoxaprop, fenoxaprop-P, florpyrauxifen, fluazifop, fluazifop-P, flufenacet, flumiclorac, flumioxazin, fluroxypyr, fluthiacet, fomesafen, halauxifen, halosulfuron, iodosulfuron, imazamox, imazapic, imazapyr, imazaquin, imazethapyr, isoxaflutole, lactofen, MCPA, mesosulfuron, mesotrione, metolachlor, S-metolachlor, metsulfuron, MSMA, nicosulfuron, orthosulfamuron, penoxsulam, pinoxaden, primisulfuron, propanil, propyzamide, pyrasulfotole, pyrithiobac, pyroxasulfone, pyroxsulam, quinclorac, quizalofop, quizalofop-P, rimsulfuron, saflufenacil, sethoxydim, sulfentrazone, sulfosulfuron, tembotrione, tetflupyrolimet, thifensulfuron, thiobencarb, tiafenacil, tolpyralate, topramezone, triallate, triasulfuron, tribenuron, triclopyr, trifloxysulfuron, trifludimoxazin, trifluralin, triflusulfuron and agriculturally acceptable salts or derivatives thereof are well-known herbicides for weed control in agricultural crops including rice.

For example, saflufenacil is marketed by BASF Corporation, Research Triangle Park, N.C., U.S.A. under the trade name Kixor® for use in selected crops including, inter alia, rice. Saflufenacil is the common name of the herbicidal compound with the IUPAC name N′-{2-chloro-4-fluoro-5-[1,2,3,6-tetrahydro-3-methyl-2,6-dioxo-4-(trifluoromethyl)pyrimidin-1-yl]benzoyl}-N-isopropyl-N-methylsulfamide and the Chemical Abstracts name 2-chloro-5-[3,6-dihydro-3-methyl-2,6-dioxo-4-(trifluoromethyl)-1(2H)-pyrimidinyl]-4-fluoro-N-[[methyl(1-methylethyl)amino]sulfonyl]benzamide that is described in the The e-Pesticide Manual, Version 5.2, British Crop Production Council, 2008-2011, entry 770. The herbicidal activity of saflufenacil is described in WO 01/083459. A crystalline and essentially solvent-free form of saflufenacil has been described in WO 08/043835. Two crystalline hydrate forms of saflufenacil have been described in WO 08/043836.

E. R. Camargo et al., “Rice Tolerance to Saflufenacil in Clomazone Weed Control Program”, International Journal of Agronomy, 2011(4), DOI:10.1155/2011/402461 describes an evaluation of the rice tolerance to saflufenacil in clomazone weed control programs. Saflufenacil was applied preemergence and postemergence on drill-seeded rice and before flooding.

Nevertheless, there is still a need to control weeds (especially aquatic weeds) in flooded rice. It is also desirable to develop practices for preventing, delaying or managing herbicide-resistant weeds (especially herbicide-resistant aquatic weeds) in flooded rice. Further, there is still a need to control weeds (especially aquatic weeds) in flooded rice while at the time preventing or minimizing injury to and/or yield loss in the crop species.

### SUMMARY OF THE INVENTION

Thus, an object of the present invention lies in the effective control of weeds (especially aquatic weeds) in flooded rice.

Another object of the present invention is to effectively control herbicide-resistant weeds (especially herbicide-resistant aquatic weeds) in flooded rice.

Yet another object of the present invention lies in the effective control of weeds (especially aquatic weeds) in flooded rice without injury to and/or yield loss in the crop species.

These and further objects are achieved by the method as described below.

Accordingly, in one aspect of the invention there is provided a method for controlling undesirable vegetation in an aquatic environment in which a rice plant is growing, said method comprising applying to the aquatic environment a herbicidally effective amount of a herbicide A pre-emergence or early post-emergence of the undesirable vegetation and after germination of the rice seedlings wherein the herbicide A is selected from acetochlor, acifluorfen, alachlor, aminopyralid, bensulfuron, benzobicyclon, bicyclopyrone, bispyribac, butylate, carfentrazone, chlorimuron, chlorsulfuron, cinmethylin, clethodim, clodinafop, clomazone, clopyralid, cycloate, cyhalofop, 2,4-D, dicamba, diflufenzopyr, dimethenamid, dimethenamid-P, dithiopyr, EPTC, ethalfluralin, ethofumesate, fenoxaprop, fenoxaprop-P, florpyrauxifen, fluazifop, fluazifop-P, flufenacet, flumiclorac, flumioxazin, fluroxypyr, fluthiacet, fomesafen, halauxifen, halosulfuron, iodosulfuron, imazamox, imazapic, imazapyr, imazaquin, imazethapyr, isoxaflutole, lactofen, MCPA, mesosulfuron, mesotrione, metolachlor, S-metolachlor, metsulfuron, MSMA, nicosulfuron, orthosulfamuron, penoxsulam, pinoxaden, primisulfuron, propanil, propyzamide, pyrasulfotole, pyrithiobac, pyroxasulfone, pyroxsulam, quinclorac, quizalofop, quizalofop-P, rimsulfuron, saflufenacil, sethoxydim, sulfentrazone, sulfosulfuron, tembotrione, tetflupyrolimet, thifensulfuron, thiobencarb, tiafenacil, tolpyralate, topramezone, triallate, triasulfuron, tribenuron, triclopyr, trifloxysulfuron, trifludimoxazin, trifluralin, triflusulfuron and agriculturally acceptable salts or derivatives thereof.

In one embodiment, a herbicidally effective amount of the herbicide A as defined herein is applied pre-emergence of the undesirable vegetation and after germination of the rice seedlings.

In another embodiment, a herbicidally effective amount of the herbicide A as defined herein is applied early post-emergence of the undesirable vegetation and after germination of the rice seedlings.

In yet another embodiment, a herbicidally effective amount of the herbicide A as defined herein is applied shortly before or shortly after emergence of the undesirable vegetation and after germination of the rice seedlings.

The term “herbicidally effective amount” denotes an amount of the active ingredient(s), which is sufficient for controlling unwanted plants, especially for controlling unwanted plants in cultivated plants and which does not result in a substantial damage to the treated plants. Such an amount can vary in a broad range and is dependent on various factors, such as the plants to be controlled, the treated cultivated plant or material, the climatic conditions and the specific composition according to the invention used.

The terms “plants” and “vegetation”, as used herein, include germinant seeds, emerging seedlings, plants emerging from vegetative propagules, and established vegetation.

The term “locus”, as used herein, means the area in which the undesirable vegetation or rice plants are growing or will grow.

The terms “controlling” and “combating”, as used herein, are synonyms.

The terms “undesirable vegetation”, “harmful plants”, “unwanted plants”, “weeds” and “weed species”, as used herein, are synonyms.

The term “aquatic environment”, as used herein, means any standing water in which a rice plant is growing and requires weed control such as, for example, a flooded rice field, a flooded rice paddy, a pond or a lake. Preferably, the aquatic environment is a flooded rice field, a flooded rice paddy, a pond, a tank or a lake, more preferably a flooded rice field or a flooded rice paddy and in particular a flooded rice field. In another embodiment, the aquatic environment is a manmade water supply for livestock such as, for example, a pond or a tank.

As used herein, ranges specifically include the values provided as endpoint values of the range. As used herein, ranges specifically include all the integer values of the range. For example, a range of 1 to 100 or from 1 to 100 specifically includes the end point values of 1 and 100.

Further embodiments of the invention are evident from the description, the examples and the claims. It is to be understood that the features mentioned above and still to be illustrated below of the subject matter of the invention can be applied not only in the combination given in each particular case but also in other combinations, without leaving the scope of the invention.

### DETAILED DESCRIPTION OF THE INVENTION

Surprisingly, it has been found that the specific herbicides A selected from acetochlor, acifluorfen, alachlor, aminopyralid, bensulfuron, benzobicyclon, bicyclopyrone, bispyribac, butylate, carfentrazone, chlorimuron, chlorsulfuron, cinmethylin, clethodim, clodinafop, clomazone, clopyralid, cycloate, cyhalofop, 2,4-D, dicamba, diflufenzopyr, dimethenamid, dimethenamid-P, dithiopyr, EPTC, ethalfluralin, ethofumesate, fenoxaprop, fenoxaprop-P, florpyrauxifen, fluazifop, fluazifop-P, flufenacet, flumiclorac, flumioxazin, fluroxypyr, fluthiacet, fomesafen, halauxifen, halosulfuron, iodosulfuron, imazamox, imazapic, imazapyr, imazaquin, imazethapyr, isoxaflutole, lactofen, MCPA, mesosulfuron, mesotrione, metolachlor, S-metolachlor, metsulfuron, MSMA, nicosulfuron, orthosulfamuron, penoxsulam, pinoxaden, primisulfuron, propanil, propyzamide, pyrasulfotole, pyrithiobac, pyroxasulfone, pyroxsulam, quinclorac, quizalofop, quizalofop-P, rimsulfuron, saflufenacil, sethoxydim, sulfentrazone, sulfosulfuron, tembotrione, tetflupyrolimet, thifensulfuron, thiobencarb, tiafenacil, tolpyralate, topramezone, triallate, triasulfuron, tribenuron, triclopyr, trifloxysulfuron, trifludimoxazin, trifluralin, triflusulfuron and agriculturally acceptable salts or derivatives thereof provide effective weed control when applied to an aquatic environment in which rice plants are cultivated (e.g., a flooded rice field) pre-emergence or early post-emergence of the undesirable vegetation and after germination of the rice seedlings.

Another advantage of this invention is that the specific herbicides A as defined herein (in particular saflufenacil) or a suitable composition or formulation thereof can be applied directly into or onto the water of an aquatic environment (in particular a flooded rice field or paddy), such that the active ingredient becomes dispersed in the total water volume of the flooded rice field or paddy but also quickly settles into the seed zone, resulting in the active ingredient coming into contact with the weed seed and/or germinated weed seed inhibiting growth.

Furthermore, the method of the present invention provides effective control of various grass weeds, sedges and/or broadleaf weeds occurring in flooded rice fields, which are troublesome and difficult to control and could cause significant yield reduction if left uncontrolled.

Yet another advantage is that the method of this invention does not cause injury of the rice plants. This is because the rice plant has germinated and grown out of the stage where the individual herbicide A may damage the plant, but still be effective at controlling weed germination.

The herbicide A used in the method of this invention is selected from acetochlor, acifluorfen, alachlor, aminopyralid, bensulfuron, benzobicyclon, bicyclopyrone, bispyribac, butylate, carfentrazone, chlorimuron, chlorsulfuron, cinmethylin, clethodim, clodinafop, clomazone, clopyralid, cycloate, cyhalofop, 2,4-D, dicamba, diflufenzopyr, dimethenamid, dimethenamid-P, dithiopyr, EPTC, ethalfluralin, ethofumesate, fenoxaprop, fenoxaprop-P, florpyrauxifen, fluazifop, fluazifop-P, flufenacet, flumiclorac, flumioxazin, fluroxypyr, fluthiacet, fomesafen, halauxifen, halosulfuron, iodosulfuron, imazamox, imazapic, imazapyr, imazaquin, imazethapyr, isoxaflutole, lactofen, MCPA, mesosulfuron, mesotrione, metolachlor, S-metolachlor, metsulfuron, MSMA, nicosulfuron, orthosulfamuron, penoxsulam, pinoxaden, primisulfuron, propanil, propyzamide, pyrasulfotole, pyrithiobac, pyroxasulfone, pyroxsulam, quinclorac, quizalofop, quizalofop-P, rimsulfuron, saflufenacil, sethoxydim, sulfentrazone, sulfosulfuron, tembotrione, tetflupyrolimet, thifensulfuron, thiobencarb, tiafenacil, tolpyralate, topramezone, triallate, triasulfuron, tribenuron, triclopyr, trifloxysulfuron, trifludimoxazin, trifluralin, triflusulfuron and agriculturally acceptable salts or derivatives thereof.

Preferably, the herbicide A is selected from acetochlor, acifluorfen, acifluorfen-methyl, acifluorfen-sodium, alachlor, aminopyralid, aminopyralid-potassium, aminopyralid-dimethylammonium, aminopyralid-tripromine, bensulfuron, bensulfuron-methyl, benzobicyclon, bicyclopyrone, bispyribac, bispyribac-sodium, butylate, carfentrazone, carfentrazone-ethyl, chlorimuron, chlorimuron-ethyl, chlorsulfuron, cinmethylin, clethodim, clodinafop, clodinafop-propargyl, clomazone, clopyralid, clopyralid-potassium, clopyralid-dimethylammonium, clopyralid-olamine, clopyralid-tripromine, clopyralid-methyl, cycloate, cyhalofop, cyhalofop-butyl, 2,4-D, 2,4-D-ammonium, 2,4-D-dimethylammonium, 2,4-D-diethylammonium, 2,4-D-diethanolammonium (2,4-D-diolamine), 2,4-D-triethanolammonium, 2,4-D-isopropylammonium, 2,4-D-triisopropanolammonium, 2,4-D-heptylammonium, 2,4-D-dodecylammonium, 2,4-D-tetradecylammonium, 2,4-D-triethylammonium, 2,4-D-tris(2-hydroxypropyl)ammonium, 2,4-D-tris(isopropyl)ammonium, 2,4-D-trolamine, 2,4-D-lithium, 2,4-D-sodium, 2,4-D-N,N,N-trimethylethanolammonium (2,4-D choline), 2,4-D-butotyl, 2,4-D-2-butoxypropyl, 2,4-D-3-butoxypropyl, 2,4-D-butyl, 2,4-D-ethyl, 2,4-D-ethylhexyl, 2,4-D-isobutyl, 2,4-D-isooctyl, 2,4-D-isopropyl, 2,4-D-meptyl, 2,4-D-methyl, 2,4-D-octyl, 2,4-D-pentyl, 2,4-D-propyl, 2,4-D-tefuryl, dicamba, dicamba-sodium, dicamba-potassium, dicamba-methylammonium, dicamba-dimethylammonium, dicamba-isopropylammonium, dicamba-diglycolamine, dicamba-olamine, dicamba-diolamine, dicamba-trolamine, dicamba-N,N-bis-(3-aminopropyl)methylamine, dicamba-diethylenetriamine, dicamba-methyl, dicamba-butotyl, diflufenzopyr, diflufenzopyr-sodium, dimethenamid, dimethenamid-P, dithiopyr, EPTC, ethalfluralin, ethofumesate, fenoxaprop, fenoxaprop-ethyl, fenoxaprop-P, fenoxaprop-P-ethyl, florpyrauxifen, florpyrauxifen-benzyl, fluazifop, fluazifop-butyl, fluazifop-P, fluazifop-P-butyl, flufenacet, flumiclorac, flumiclorac-pentyl, flumioxazin, fluroxypyr, fluroxypyr-butometyl, fluroxypyr-meptyl, fluthiacet, fluthiacet-methyl, fomesafen, fomesafen-sodium, halauxifen, halauxifen-methyl, halosulfuron, halosulfuron-methyl, iodosulfuron, iodosulfuron-methyl, iodosulfuron-methyl-sodium, imazamox, imazamox-sodium, imazamox-ammonium, imazapic, imazapic-ammonium, imazapic-isopropylammonium, imazapyr, imazapyr-ammonium, imazapyr-isopropylammonium, imazaquin, imazaquin-ammonium, imazaquin-methyl, imazaquin-sodium, imazethapyr, imazethapyr-ammonium, imazethapyr-isopropylammonium, isoxaflutole, lactofen, MCPA, MCPA-butotyl, MCPA-butyl, MCPA-dimethylammonium, MCPA-diolamine, MCPA-ethyl, MCPA-thioethyl, MCPA-2-ethylhexyl, MCPA-isobutyl, MCPA-isoctyl, MCPA-isopropyl, MCPA-isopropylammonium, MCPA-methyl, MCPA-olamine, MCPA-potassium, MCPA-sodium, MCPA-trolamine, mesosulfuron, mesosulfuron-methyl, mesotrione, metolachlor, S-metolachlor, metsulfuron, metsulfuron-methyl, MSMA, nicosulfuron, orthosulfamuron, penoxsulam, pinoxaden, primisulfuron, primisulfuron-methyl, propanil, propyzamide, pyrasulfotole, pyrithiobac, pyrithiobac-sodium, pyroxasulfone, pyroxsulam, quinclorac, quinclorac-dimethylammonium, quinclorac-methyl, quizalofop, quizalofop-ethyl, quizalofop-tefuryl, quizalofop-P, quizalofop-P-ethyl, quizalofop-P-tefuryl, rimsulfuron, saflufenacil, sethoxydim, sulfentrazone, sulfosulfuron, tembotrione, tetflupyrolimet, thifensulfuron, thifensulfuron-methyl, thiobencarb, tiafenacil, tolpyralate, topramezone, triallate, triasulfuron, tribenuron, tribenuron-methyl, triclopyr, triclopyr-triethylammonium, triclopyr-ethyl, triclopyr-butotyl, triclopyr-choline, trifloxysulfuron, trifloxysulfuron-sodium, trifludimoxazin, trifluralin, triflusulfuron and triflusulfuron-methyl.

More preferably, the herbicide A is selected from bensulfuron, benzobicyclon, bispyribac, carfentrazone, cinmethylin, clomazone, cyhalofop, dimethenamid, dimethenamid-P, halosulfuron, metolachlor, S-metolachlor, orthosulfamuron, penoxsulam, propanil, pyroxasulfone, saflufenacil, thiobencarb, triclopyr and agriculturally acceptable salts or esters thereof.

Even more preferably, the herbicide A is selected from bensulfuron, bensulfuron-methyl, benzobicyclon, bispyribac, bispyribac-sodium, carfentrazone, carfentrazone-ethyl, cinmethylin, clomazone, cyhalofop, cyhalofop-butyl, dimethenamid, dimethenamid-P, halosulfuron, halosulfuron-methyl, metolachlor, S-metolachlor, orthosulfamuron, penoxsulam, propanil, pyroxasulfone, saflufenacil, thiobencarb, triclopyr, triclopyr-triethylammonium, triclopyr-ethyl, triclopyr-butotyl and triclopyr-choline.

Still more preferably, the herbicide A is selected from bensulfuron-methyl, benzobicyclon, bispyribac-sodium, carfentrazone-ethyl, cinmethylin, clomazone, cyhalofop-butyl, dimethenamid-P, halosulfuron-methyl, metolachlor, S-metolachlor, orthosulfamuron, penoxsulam, propanil, pyroxasulfone, saflufenacil, thiobencarb and triclopyr-choline.

Yet more preferably, the herbicide A is selected from clomazone, dimethenamid-P, metolachlor, S-metolachlor, pyroxasulfone and saflufenacil.

In particular, the herbicide A is selected from clomazone, metolachlor, S-metolachlor and saflufenacil.

In an especially preferred embodiment, the herbicide A is selected from clomazone and saflufenacil.

In another especially preferred embodiment, the herbicide A is selected from metolachlor, S-metolachlor and saflufenacil, preferably from S-metolachlor and saflufenacil.

In a particularly preferred embodiment, the herbicide A is saflufenacil.

In another particularly preferred embodiment, the herbicide A is clomazone.

In another particularly preferred embodiment, the herbicide A is metolachlor or S-metolachlor, preferably S-metolachlor.

In another preferred embodiment, the herbicide A is bensulfuron or bensulfuron-methyl, preferably bensulfuron-methyl.

In another preferred embodiment, the herbicide A is benzobicyclon.

In another preferred embodiment, the herbicide A is bispyribac or bispyribac-sodium, preferably bispyribac-sodium.

In another preferred embodiment, the herbicide A is carfentrazone or carfentrazone-ethyl, preferably carfentrazone-ethyl.

In another preferred embodiment, the herbicide A is cinmethylin.

In another preferred embodiment, the herbicide A is cyhalofop or cyhalofop-butyl, preferably cyhalofop-butyl.

In another preferred embodiment, the herbicide A is dimethenamid or dimethenamid-P, preferably dimethenamid-P.

In another preferred embodiment, the herbicide A is halosulfuron or halosulfuron-methyl, preferably halosulfuron-methyl.

In another preferred embodiment, the herbicide A is orthosulfamuron.

In another preferred embodiment, the herbicide A is penoxsulam.

In another preferred embodiment, the herbicide A is propanil.

In another preferred embodiment, the herbicide A is pyroxasulfone.

In another preferred embodiment, the herbicide A is thiobencarb.

In another preferred embodiment, the herbicide A is triclopyr or triclopyr-choline, preferably triclopyr-choline.

In another embodiment, a composition comprising the herbicide A selected from acetochlor, acifluorfen, alachlor, aminopyralid, bensulfuron, benzobicyclon, bicyclopyrone, bispyribac, butylate, carfentrazone, chlorimuron, chlorsulfuron, cinmethylin, clethodim, clodinafop, clomazone, clopyralid, cycloate, cyhalofop, 2,4-D, dicamba, diflufenzopyr, dimethenamid, dimethenamid-P, dithiopyr, EPTC, ethalfluralin, ethofumesate, fenoxaprop, fenoxaprop-P, florpyrauxifen, fluazifop, fluazifop-P, flufenacet, flumiclorac, flumioxazin, fluroxypyr, fluthiacet, fomesafen, halauxifen, halosulfuron, iodosulfuron, imazamox, imazapic, imazapyr, imazaquin, imazethapyr, isoxaflutole, lactofen, MCPA, mesosulfuron, mesotrione, metolachlor, S-metolachlor, metsulfuron, MSMA, nicosulfuron, orthosulfamuron, penoxsulam, pinoxaden, primisulfuron, propanil, propyzamide, pyrasulfotole, pyrithiobac, pyroxasulfone, pyroxsulam, quinclorac, quizalofop, quizalofop-P, rimsulfuron, saflufenacil, sethoxydim, sulfentrazone, sulfosulfuron, tembotrione, tetflupyrolimet, thifensulfuron, thiobencarb, tiafenacil, tolpyralate, topramezone, triallate, triasulfuron, tribenuron, triclopyr, trifloxysulfuron, trifludimoxazin, trifluralin, triflusulfuron and agriculturally acceptable salts or derivatives thereof is applied.

Preferably, a composition comprising the herbicide A selected from acetochlor, acifluorfen, acifluorfen-methyl, acifluorfen-sodium, alachlor, aminopyralid, aminopyralid-potassium, aminopyralid-dimethylammonium, aminopyralid-tripromine, bensulfuron, bensulfuron-methyl, benzobicyclon, bicyclopyrone, bispyribac, bispyribac-sodium, butylate, carfentrazone, carfentrazone-ethyl, chlorimuron, chlorimuron-ethyl, chlorsulfuron, cinmethylin, clethodim, clodinafop, clodinafop-propargyl, clomazone, clopyralid, clopyralid-potassium, clopyralid-dimethylammonium, clopyralid-olamine, clopyralid-tripromine, clopyralid-methyl, cycloate, cyhalofop, cyhalofop-butyl, 2,4-D, 2,4-D-ammonium, 2,4-D-dimethylammonium, 2,4-D-diethylammonium, 2,4-D-diethanolammonium (2,4-D-diolamine), 2,4-D-triethanolammonium, 2,4-D-isopropylammonium, 2,4-D-triisopropanolammonium, 2,4-D-heptylammonium, 2,4-D-dodecylammonium, 2,4-D-tetradecylammonium, 2,4-D-triethylammonium, 2,4-D-tris(2-hydroxypropyl)ammonium, 2,4-D-tris(isopropyl)ammonium, 2,4-D-trolamine, 2,4-D-lithium, 2,4-D-sodium, 2,4-D-N,N,N-trimethylethanolammonium (2,4-D choline), 2,4-D-butotyl, 2,4-D-2-butoxypropyl, 2,4-D-3-butoxypropyl, 2,4-D-butyl, 2,4-D-ethyl, 2,4-D-ethylhexyl, 2,4-D-isobutyl, 2,4-D-isooctyl, 2,4-D-isopropyl, 2,4-D-meptyl, 2,4-D-methyl, 2,4-D-octyl, 2,4-D-pentyl, 2,4-D-propyl, 2,4-D-tefuryl, dicamba, dicamba-sodium, dicamba-potassium, dicamba-methylammonium, dicamba-dimethylammonium, dicamba-isopropylammonium, dicamba-diglycolamine, dicamba-olamine, dicamba-diolamine, dicamba-trolamine, dicamba-N,N-bis-(3-aminopropyl)methylamine, dicamba-diethylenetriamine, dicamba-methyl, dicamba-butotyl, diflufenzopyr, diflufenzopyr-sodium, dimethenamid, dimethenamid-P, dithiopyr, EPTC, ethalfluralin, ethofumesate, fenoxaprop, fenoxaprop-ethyl, fenoxaprop-P, fenoxaprop-P-ethyl, florpyrauxifen, florpyrauxifen-benzyl, fluazifop, fluazifop-butyl, fluazifop-P, fluazifop-P-butyl, flufenacet, flumiclorac, flumiclorac-pentyl, flumioxazin, fluroxypyr, fluroxypyr-butometyl, fluroxypyr-meptyl, fluthiacet, fluthiacet-methyl, fomesafen, fomesafen-sodium, halauxifen, halauxifen-methyl, halosulfuron, halosulfuron-methyl, iodosulfuron, iodosulfuron-methyl, iodosulfuron-methyl-sodium, imazamox, imazamox-sodium, imazamox-ammonium, imazapic, imazapic-ammonium, imazapic-isopropylammonium, imazapyr, imazapyr-ammonium, imazapyr-isopropylammonium, imazaquin, imazaquin-ammonium, imazaquin-methyl, imazaquin-sodium, imazethapyr, imazethapyr-ammonium, imazethapyr-isopropylammonium, isoxaflutole, lactofen, MCPA, MCPA-butotyl, MCPA-butyl, MCPA-dimethylammonium, MCPA-diolamine, MCPA-ethyl, MCPA-thioethyl, MCPA-2-ethylhexyl, MCPA-isobutyl, MCPA-isoctyl, MCPA-isopropyl, MCPA-isopropylammonium, MCPA-methyl, MCPA-olamine, MCPA-potassium, MCPA-sodium, MCPA-trolamine, mesosulfuron, mesosulfuron-methyl, mesotrione, metolachlor, S-metolachlor, metsulfuron, metsulfuron-methyl, MSMA, nicosulfuron, orthosulfamuron, penoxsulam, pinoxaden, primisulfuron, primisulfuron-methyl, propanil, propyzamide, pyrasulfotole, pyrithiobac, pyrithiobac-sodium, pyroxasulfone, pyroxsulam, quinclorac, quinclorac-dimethylammonium, quinclorac-methyl, quizalofop, quizalofop-ethyl, quizalofop-tefuryl, quizalofop-P, quizalofop-P-ethyl, quizalofop-P-tefuryl, rimsulfuron, saflufenacil, sethoxydim, sulfentrazone, sulfosulfuron, tembotrione, tetflupyrolimet, thifensulfuron, thifensulfuron-methyl, thiobencarb, tiafenacil, tolpyralate, topramezone, triallate, triasulfuron, tribenuron, tribenuron-methyl, triclopyr, triclopyr-triethylammonium, triclopyr-ethyl, triclopyr-butotyl, triclopyr-choline, trifloxysulfuron, trifloxysulfuron-sodium, trifludimoxazin, trifluralin, triflusulfuron and triflusulfuron-methyl is applied.

More preferably, a composition comprising the herbicide A selected from bensulfuron, benzobicyclon, bispyribac, carfentrazone, cinmethylin, clomazone, cyhalofop, dimethenamid, dimethenamid-P, halosulfuron, metolachlor, S-metolachlor, orthosulfamuron, penoxsulam, propanil, pyroxasulfone, saflufenacil, thiobencarb, triclopyr and agriculturally acceptable salts or esters thereof is applied.

Even more preferably, a composition comprising the herbicide A selected from bensulfuron, bensulfuron-methyl, benzobicyclon, bispyribac, bispyribac-sodium, carfentrazone, carfentrazone-ethyl, cinmethylin, clomazone, cyhalofop, cyhalofop-butyl, dimethenamid, dimethenamid-P, halosulfuron, halosulfuron-methyl, metolachlor, S-metolachlor, orthosulfamuron, penoxsulam, propanil, pyroxasulfone, saflufenacil, thiobencarb, triclopyr, triclopyr-triethylammonium, triclopyr-ethyl, triclopyr-butotyl and triclopyr-choline is applied.

Still more preferably, a composition comprising the herbicide A is selected from bensulfuron-methyl, benzobicyclon, bispyribac-sodium, carfentrazone-ethyl, cinmethylin, clomazone, cyhalofop-butyl, dimethenamid-P, halosulfuron-methyl, metolachlor, S-metolachlor, orthosulfamuron, penoxsulam, propanil, pyroxasulfone, saflufenacil, thiobencarb and triclopyr-choline is applied.

Yet more preferably, a composition comprising the herbicide A selected from clomazone, dimethenamid-P, metolachlor, S-metolachlor, pyroxasulfone and saflufenacil is applied.

In particular, a composition comprising the herbicide A selected from clomazone, metolachlor, S-metolachlor and saflufenacil is applied.

In an especially preferred embodiment, a composition comprising the herbicide A selected from clomazone and saflufenacil is applied.

In another especially preferred embodiment, a composition comprising the herbicide A selected from metolachlor, S-metolachlor and saflufenacil, preferably from S-metolachlor and saflufenacil is applied.

In a particularly preferred embodiment, a composition comprising the herbicide A which is saflufenacil is applied.

In another particularly preferred embodiment, a composition comprising the herbicide A which is clomazone is applied.

In another particularly preferred embodiment, a composition comprising the herbicide A which is metolachlor or S-metolachlor (preferably S-metolachlor) is applied.

In another preferred embodiment, a composition comprising the herbicide A which is bensulfuron or bensulfuron-methyl (preferably bensulfuron-methyl) is applied.

In another preferred embodiment, a composition comprising the herbicide A which is benzobicyclon is applied.

In another preferred embodiment, a composition comprising the herbicide A which is bispyribac or bispyribac-sodium (preferably bispyribac-sodium) is applied.

In another preferred embodiment, a composition comprising the herbicide A which is carfentrazone or carfentrazone-ethyl (preferably carfentrazone-ethyl) is applied.

In another preferred embodiment, a composition comprising the herbicide A which is cinmethylin is applied.

In another preferred embodiment, a composition comprising the herbicide A which is cyhalofop or cyhalofop-butyl (preferably cyhalofop-butyl) is applied.

In another preferred embodiment, a composition comprising the herbicide A which is dimethenamid or dimethenamid-P (preferably dimethenamid-P) is applied.

In another preferred embodiment, a composition comprising the herbicide A which is halosulfuron or halosulfuron-methyl (preferably halosulfuron-methyl) is applied.

In another preferred embodiment, a composition comprising the herbicide A which is orthosulfamuron is applied.

In another preferred embodiment, a composition comprising the herbicide A which is penoxsulam is applied.

In another preferred embodiment, a composition comprising the herbicide A which is propanil is applied.

In another preferred embodiment, a composition comprising the herbicide A which is pyroxasulfone is applied.

In another preferred embodiment, a composition comprising the herbicide A which is thiobencarb is applied.

In another preferred embodiment, a composition comprising the herbicide A which is triclopyr or triclopyr-choline (preferably triclopyr-choline) is applied.

Thus, a preferred embodiment of the invention relates to a method for controlling undesirable vegetation in an aquatic environment in which a rice plant is growing, said method comprising applying to the aquatic environment a herbicidally effective amount of a composition comprising the herbicide A as defined herein (in particular saflufenacil) pre-emergence or early post-emergence of the undesirable vegetation and after germination of the rice seedlings.

In one embodiment, this invention relates to a method for controlling undesirable vegetation in an aquatic environment in which a rice plant is growing, said method comprising applying to the aquatic environment a herbicidally effective amount of a composition comprising the herbicide A as defined herein (in particular saflufenacil) pre-emergence of the undesirable vegetation and after germination of the rice seedlings.

In another embodiment, this invention relates to a method for controlling undesirable vegetation in an aquatic environment in which a rice plant is growing, said method comprising applying to the aquatic environment a herbicidally effective amount of a composition comprising the herbicide A as defined herein (in particular saflufenacil) early post-emergence of the undesirable vegetation and after germination of the rice seedlings.

In yet another embodiment, this invention relates to a method for controlling undesirable vegetation in an aquatic environment in which a rice plant is growing, said method comprising applying to the aquatic environment a herbicidally effective amount of a composition comprising the herbicide A as defined herein (in particular saflufenacil) shortly before or shortly after emergence of the undesirable vegetation and after germination of the rice seedlings.

Preferably, the herbicide A as defined herein (in particular saflufenacil) is present in the composition in the form of liquid droplets, microcapsules or solid particles, more preferably in the form of microcapsules or solid particles and most preferably in the form of microcapsules.

As used herein, the term “microcapsules” means small spherical particles in the size range of 1 to 150 μm which comprise a distinct capsule wall (mostly a polymeric material) surrounding a core comprising the active ingredient(s) such as the herbicide A. The term “microcapsules” as used herein is not limited to a core and shell structure but also includes any microparticle in the aforementioned size range wherein the active ingredient(s) such as the herbicide A is surrounded or embedded by a matrix material (mostly a polymeric material).

In still another preferred embodiment, a liquid or solid formulation comprising herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil), each being optionally diluted with water, is applied. The term “being optionally diluted with water” as used herein means in each case that the respective formulation is present or applied either undiluted or diluted with water. Exemplary liquid formulations include emulsifiable concentrates (EC), capsule suspensions (CS) or suspension concentrates (SC), with capsule suspensions (CS) being preferred. Any of the aforementioned liquid formulations are normally intended for dilution with water before application. In certain embodiments, the aforementioned liquid formulations can also be applied neat without dilution with water such as, for example, the application of capsule suspensions (CS) by drones.

Exemplary solid formulations include granule products, for example water-dispersible granules (WG) and granules (GR), with granules (GR) being preferred. Water-dispersible granules (WG) are applied after disintegration and/or dispersion in water. Granules (GR) are ready to use for direct application to the aquatic environment without any further dilution or mixing step. The aforementioned and further formulation types are defined in the “Catalogue of pesticide formulation types and international coding system”, Technical Monograph No. 2, 6^{th} Ed. May 2008, CropLife International.

The aforementioned formulations can be prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005.

Suitable auxiliaries are solvents, liquid carriers, solid carriers or fillers, surfactants, dispersants, emulsifiers, wetting agents, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof.

Suitable solid carriers or fillers are mineral earths, e.g., silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e.g. ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the herbicide A as defined herein on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), inorganic clays (organically modified or unmodified), polycarboxylates, and silicates.

Suitable bactericides are bronopol and isothiazolinone derivatives such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

Examples for the aforementioned formulation types and their preparation are given below:

### i) Emulsifiable Concentrates (EC)

5-70 wt % of the herbicide A (as defined herein) or a composition comprising the herbicide A (as defined herein) and at least one further compound selected from the herbicides B (as defined herein) and safeners C (as defined herein) and 5-10 wt % emulsifiers (e.g. calcium dodecylbenzenesulfonate and castor oil ethoxylate) are dissolved in water-insoluble organic solvent (e.g. aromatic hydrocarbon) ad 100 wt %. Dilution with water gives an emulsion.

### ii) Suspension Concentrates (SC)

In an agitated ball mill, 20-60 wt % of the herbicide A (as defined herein) or a composition comprising the herbicide A (as defined herein) and at least one further compound selected from the herbicides B (as defined herein) and safeners C (as defined herein) are comminuted with addition of 2-10 wt % dispersants and wetting agents (e.g. sodium lignosulfonate and alcohol ethoxylate), 0.1-2 wt % thickener (e.g. xanthan gum) and water ad 100 wt % to give a fine active substance suspension. Dilution with water gives a stable suspension of the active substance.

iii) Capsule Suspensions (CS)

An oil phase comprising 5-70 wt % of the herbicide A (as defined herein) or a composition comprising the herbicide A (as defined herein) and at least one further compound selected from the herbicides B (as defined herein) and safeners C (as defined herein), 0-40 wt % water insoluble organic solvent (e.g. aromatic hydrocarbon), 2-15 wt % acrylic monomers (e.g. methylmethacrylate, methacrylic acid and a di- or triacrylate) are dispersed into an aqueous solution of a protective colloid (e.g. polyvinyl alcohol). Radical polymerization initiated by a radical initiator results in the formation of poly(meth)acrylate microcapsules. Alternatively, an oil phase comprising 5-50 wt % of the herbicide A (as defined herein), 0-40 wt % water insoluble organic solvent (e.g. aromatic hydrocarbon), and an isocyanate monomer (e.g. diphenylmethene-4,4′-diisocyanate) are dispersed into an aqueous solution of a protective colloid (e.g. polyvinyl alcohol). The addition of a polyamine (e.g. hexamethylenediamine) results in the formation of polyurea microcapsules. The monomers amount to 1-10 wt %. The wt % relate to the total CS formulation.

### iv) Water-Dispersible Granules (WG)

50-80 wt % of the herbicide A (as defined herein) or a composition comprising the herbicide A (as defined herein) and at least one further compound selected from the herbicides B (as defined herein) and safeners C (as defined herein) are ground finely with addition of dispersants and wetting agents (e.g. sodium lignosulfonate and alcohol ethoxylate) ad 100 wt % and prepared as water-dispersible or water-soluble granules by means of technical appliances (e. g. extrusion, spray tower, fluidized bed). Dilution with water gives a stable dispersion or solution of the active substance.

### v) Granules (GR)

0.5-30 wt % of the herbicide A (as defined herein) or a composition comprising the herbicide A (as defined herein) and at least one further compound selected from the herbicides B (as defined herein) and safeners C (as defined herein) is ground finely and associated with solid carrier (e.g. silicate) ad 100 wt %. Granulation is achieved by extrusion, spray-drying or the fluidized bed.

The aforementioned formulation types i) to v) may optionally comprise further auxiliaries, such as 0.1-1 wt % bactericides, 5-15 wt % anti-freezing agents, 0.1-1 wt % anti-foaming agents, and 0.1-1 wt % colorants.

In a preferred embodiment of the method of this invention, an emulsifiable concentrate (EC) comprising the herbicide A being diluted with water, a suspension concentrate (SC) comprising the herbicide A being diluted with water, a capsule suspension (CS) comprising the herbicide A being optionally diluted with water or granules (GR) comprising the herbicide A is applied. More preferably, an emulsifiable concentrate (EC) comprising the herbicide A being diluted with water, a capsule suspension (CS) comprising the herbicide A being optionally diluted with water or granules (GR) comprising the herbicide A is applied. Even more preferably, a capsule suspension (CS) comprising the herbicide A being optionally diluted with water or granules (GR) comprising the herbicide A is applied. Most preferably, a capsule suspension (CS) comprising the herbicide A being optionally diluted with water is applied. In another embodiment, a suspension concentrate (SC) comprising the herbicide A being diluted with water or a capsule suspension (CS) comprising the herbicide A being optionally diluted with water is applied. In another embodiment, an emulsifiable concentrate (EC) comprising the herbicide A being diluted with water or a capsule suspension (CS) comprising the herbicide A being optionally diluted with water is applied. In another embodiment, an emulsifiable concentrate (EC) comprising the herbicide A being diluted with water is applied. In another embodiment, a suspension concentrate (SC) comprising the herbicide A being diluted with water is applied. In another embodiment, a capsule suspension (CS) comprising the herbicide A or a capsule suspension (CS) comprising the herbicide A being diluted with water is applied. In another embodiment, a capsule suspension (CS) comprising the herbicide A is applied. In another embodiment, a capsule suspension (CS) comprising the herbicide A being diluted with water is applied. In another embodiment, granules (GR) comprising the herbicide A is applied.

In another preferred embodiment of the method of this invention, the composition comprising the herbicide A is an emulsifiable concentrate (EC) comprising the herbicide A being diluted with water, a suspension concentrate (SC) comprising the herbicide A being diluted with water, a capsule suspension (CS) comprising the herbicide A being optionally diluted with water or granules (GR) comprising the herbicide A. More preferably, the composition comprising the herbicide A is an emulsifiable concentrate (EC) comprising the herbicide A being diluted with water, a capsule suspension (CS) comprising the herbicide A being optionally diluted with water or granules (GR) comprising the herbicide A. Even more preferably, the composition comprising the herbicide A is a capsule suspension (CS) comprising the herbicide A being optionally diluted with water or granules (GR) comprising the herbicide A. Most preferably, the composition comprising the herbicide A is a capsule suspension (CS) comprising the herbicide A being optionally diluted with water. In another embodiment, the composition comprising the herbicide A is a suspension concentrate (SC) comprising the herbicide A being diluted with water or a capsule suspension (CS) comprising the herbicide A being optionally diluted with water. In another embodiment, the composition comprising the herbicide A is an emulsifiable concentrate (EC) comprising the herbicide A being diluted with water or a capsule suspension (CS) comprising the herbicide A being optionally diluted with water. In another embodiment, the composition comprising the herbicide A is an emulsifiable concentrate (EC) comprising the herbicide A being diluted with water. In another embodiment, the composition comprising the herbicide A is a suspension concentrate (SC) comprising the herbicide A being diluted with water. In another embodiment, the composition comprising the herbicide A is a capsule suspension (CS) comprising the herbicide A or a capsule suspension (CS) comprising the herbicide A being diluted with water. In another embodiment, the composition comprising the herbicide A is a capsule suspension (CS) comprising the herbicide A. In another embodiment, the composition comprising the herbicide A is a capsule suspension (CS) comprising the herbicide A being diluted with water. In another embodiment, the composition comprising the herbicide A is granules (GR) comprising the herbicide A.

In still another preferred embodiment of the method of this invention, an emulsion obtained from diluting an emulsifiable concentrate (EC) comprising the herbicide A with water, a dilute aqueous suspension obtained from diluting a suspension concentrate (SC) comprising the herbicide A with water, a capsule suspension (CS) comprising the herbicide A, a dilute aqueous suspension obtained from diluting a capsule suspension (CS) comprising the herbicide A with water or granules (GR) comprising the herbicide A is applied. More preferably, an emulsion obtained from diluting an emulsifiable concentrate (EC) comprising the herbicide A with water, a capsule suspension (CS) comprising the herbicide A, a dilute aqueous suspension obtained from diluting a capsule suspension (CS) comprising the herbicide A with water or granules (GR) comprising the herbicide A is applied. Even more preferably, a capsule suspension (CS) comprising the herbicide A, a dilute aqueous suspension obtained from diluting a capsule suspension (CS) comprising the herbicide A with water or granules (GR) comprising the herbicide A is applied. Most preferably, a capsule suspension (CS) comprising the herbicide A or a dilute aqueous suspension obtained from diluting a capsule suspension (CS) comprising the herbicide A with water is applied. In another embodiment, a dilute aqueous suspension obtained from diluting a suspension concentrate (SC) comprising the herbicide A with water, a capsule suspension (CS) comprising the herbicide A or a dilute aqueous suspension obtained from diluting a capsule suspension (CS) comprising the herbicide A with water is applied. In another embodiment, an emulsion obtained from diluting an emulsifiable concentrate (EC) comprising the herbicide A with water, a capsule suspension (CS) comprising the herbicide A or a dilute aqueous suspension obtained from diluting a capsule suspension (CS) comprising the herbicide A with water is applied. In another embodiment, an emulsion obtained from diluting an emulsifiable concentrate (EC) comprising the herbicide A with water is applied. In another embodiment, a dilute aqueous suspension obtained from diluting a suspension concentrate (SC) comprising the herbicide A with water is applied. In another embodiment, a capsule suspension (CS) comprising the herbicide A is applied. In another embodiment, a dilute aqueous suspension obtained from diluting a capsule suspension (CS) comprising the herbicide A with water is applied.

In yet another preferred embodiment of the method of this invention, the composition comprising the herbicide A is an emulsion obtained from diluting an emulsifiable concentrate (EC) comprising the herbicide A with water, a dilute aqueous suspension obtained from diluting a suspension concentrate (SC) comprising the herbicide A with water, a capsule suspension (CS) comprising the herbicide A, a dilute aqueous suspension obtained from diluting a capsule suspension (CS) comprising the herbicide A with water or granules (GR) comprising the herbicide A. More preferably, the composition comprising the herbicide A is an emulsion obtained from diluting an emulsifiable concentrate (EC) comprising the herbicide A with water, a capsule suspension (CS) comprising the herbicide A, a dilute aqueous suspension obtained from diluting a capsule suspension (CS) comprising the herbicide A with water or granules (GR) comprising the herbicide A. Even more preferably, the composition comprising the herbicide A is a capsule suspension (CS) comprising the herbicide A, a dilute aqueous suspension obtained from diluting a capsule suspension (CS) comprising the herbicide A with water or granules (GR) comprising the herbicide A. Most preferably, the composition comprising the herbicide A is a capsule suspension (CS) comprising the herbicide A or a dilute aqueous suspension obtained from diluting a capsule suspension (CS) comprising the herbicide A with water.

In another embodiment, the composition comprising the herbicide A is a dilute aqueous suspension obtained from diluting a suspension concentrate (SC) comprising the herbicide A with water, a capsule suspension (CS) comprising the herbicide A or a dilute aqueous suspension obtained from diluting a capsule suspension (CS) comprising the herbicide A with water.

In another embodiment, the composition comprising the herbicide A is an emulsion obtained from diluting an emulsifiable concentrate (EC) comprising the herbicide A with water, a capsule suspension (CS) comprising the herbicide A or a dilute aqueous suspension obtained from diluting a capsule suspension (CS) comprising the herbicide A with water. In another embodiment, the composition comprising the herbicide A is an emulsion obtained from diluting an emulsifiable concentrate (EC) comprising the herbicide A with water. In another embodiment, the composition comprising the herbicide A is a dilute aqueous suspension obtained from diluting a suspension concentrate (SC) comprising the herbicide A with water. In another embodiment, the composition comprising the herbicide A is a capsule suspension (CS) comprising the herbicide A. In another embodiment, the composition comprising the herbicide A is a dilute aqueous suspension obtained from diluting a capsule suspension (CS) comprising the herbicide A with water.

In another preferred embodiment, the composition comprising the herbicide A is a suspension concentrate (SC) comprising saflufenacil being diluted with water, a capsule suspension (CS) comprising saflufenacil or a dilute aqueous suspension obtained from diluting the capsule suspension (CS) with water. More preferably, the composition comprising the herbicide A is composition is a capsule suspension (CS) comprising saflufenacil or a dilute aqueous suspension obtained from diluting the capsule suspension (CS) with water.

Capsule suspensions (CS) comprising saflufenacil which are suitable in this invention including methods for their preparation are described e.g., in WO 2017/037210 A1. Thus, in a preferred embodiment, the capsule suspension (CS) comprising saflufenacil is a composition comprising saflufenacil, wherein saflufenacil is present in the form of microparticles, which comprise solid saflufenacil, which is surrounded or embedded by an aminoplast polymer. The aminoplast polymer material, which surrounds or embeds the solid saflufenacil, is most preferably selected from the group consisting of melamine-formaldehyde resins, including melamine-formaldehyde resins derived from wholly or partially etherified melamine-formaldehyde condensates, and urea-formaldehyde resins and mixtures thereof. Especially, the aminoplast polymer material, which surrounds or embeds the solid saflufenacil, is a melamine-formaldehyde resin, in particular a melamine-formaldehyde resin, which is derived from wholly or partially etherified melamine-formaldehyde condensates, which may contain small amount, e.g., 1 to 20 mol.-%, based on melamine, of urea. The amount of aminoplast polymer material, which surround or embed the solid saflufenacil, will generally not exceed the amount of saflufenacil contained in the composition and is preferably at most 40% by weight, in particular at most 35% by weight and especially at most 30% by weight or at most 25% by weight, based on the total amount of saflufenacil and aminoplast polymers. The amount of aminoplast polymer material, which surround or embed the solid saflufenacil, is preferably from 0.5 to 40% by weight, in particular from 1 to 35% by weight and especially from 5 to 25% by weight, based on the total capsule weight, i.e., based on the total amount of saflufenacil and aminoplast polymers. The solid saflufenacil, which is surrounded or embedded by at least one aminoplast polymer, may be any known form of solid saflufenacil, including amorphous saflufenacil and in particular crystalline saflufenacil, e.g. the crystalline anhydrate of saflufenacil as described in WO 08/043835 or a crystalline hydrate of saflufenacil as described in WO 08/043836.

In the method of this invention, the emulsifiable concentrate (EC) comprising the herbicide A is diluted with water and is applied as an emulsion obtained from diluting the emulsifiable concentrate (EC) comprising the herbicide A with water. Typical dilution rates are in the range of 1 part by volume of the emulsifiable concentrate (EC) per at least 10 parts, preferably at least 15 parts, up to 500 parts by volume of water. In the resulting emulsion liquid droplets in which the herbicide A is suspended or dissolved in the hydrophobic organic solvent are emulsified in an aqueous continuous phase. The D₅₀ of the liquid droplets in the emulsion is generally in the range of from 1 to 100 μm, preferably from 1 to 25 μm, more preferably from 1 to 10 μm and even more preferably from 5 to 10 μm.

In a preferred embodiment, the density of the liquid droplets in the emulsion at 20° C. is generally in the range of from 1 to 1.5 g/ml and more preferably in the range of from 1.1 to 1.4 g/ml.

In another preferred embodiment, the liquid droplets in the emulsion have a D₅₀ in the range of from 5 to 10 μm and a density at 20° C. in the range of from 1 to 1.5 g/ml, preferably in the range of from 1.1 to 1.4 g/ml.

In the method of this invention, the suspension concentrate (SC) comprising the herbicide A is diluted with water and is applied as a dilute aqueous suspension obtained from diluting the suspension concentrate (SC) comprising the herbicide A with water. Typical dilution rates are in the range of 1 part by volume of the suspension concentrate (SC) per at least 5 parts, preferably at least 10 parts, up to 20 parts by volume of water. In the resulting dilute aqueous suspension solid particles of the herbicide A are suspended in an aqueous continuous phase. The D₅₀ of the solid particles in the dilute aqueous suspension is generally in the range of from 0.5 to 20 μm, preferably from 1 to 10 μm and more preferably from 1 to 5 μm.

In the method of this invention, the capsule suspension (CS) comprising the herbicide A is applied neat or diluted with water. In one embodiment, the capsule suspension (CS) comprising the herbicide A is applied neat (e.g., when applied by drones). In another embodiment, the capsule suspension (CS) comprising the herbicide A is diluted with water and applied as a dilute aqueous suspension obtained from diluting a capsule suspension (CS) comprising the herbicide A with water. Typical dilution rates are in the range of 1 part by volume of the capsule suspension (CS) per up to 20 parts by volume, preferably up to 10 parts by volume and more preferably up to 8 parts by volume of water. The D₅₀ of the capsules in the capsule suspension (CS) comprising the herbicide A or the dilute aqueous suspension obtained from diluting a capsule suspension (CS) comprising the herbicide A with water is in the range of from 1 to 100 μm, preferably from 1 to 50 μm, more preferably 1 to 25 μm, even more preferably 1.5 to 20 μm and in particular from 5 to 20 μm. The density of the capsules at 20° C. is generally in the range of from 1.06 to 1.4 g/ml.

In another preferred embodiment, the D₅₀ of the capsules in the capsule suspension (CS) or the dilute aqueous suspension (in particular the D₅₀ of the capsules in the capsule suspension (CS) comprising saflufenacil or a dilute aqueous suspension obtained from diluting the capsule suspension (CS) with water) is in the range of from 1 to 100 μm, preferably from 1 to 25 μm, more preferably from 1.5 to 20 μm and in particular from 2 to 10 μm.

In the present invention, the D₅₀ particle size values given represent the volume median particle size derived from measuring the particle size volume distribution using laser diffraction particle size analysis. The notation Dₓ means that X % of the particles (volume distribution) have a diameter value below a specified diameter D. For example, a D₅₀ of 20 μm means that 50% of the particles (volume distribution) have a diameter of less than 20 μm. The volume median diameter can be determined, for example, by wet measurement using a laser diffraction particle size distribution measuring apparatus. More specifically, liquid droplets or capsules are dispersed in water and then the volume median diameter is measured using the apparatus. The laser diffraction particle size distribution measuring apparatus includes, for example, Mastersizer 3000 (manufactured by Malvern Instruments Ltd.).

The average particle size of the granules (GR) comprising the herbicide A is generally in the range of from 0.1 to 10 mm, preferably from 0.1 to 3.5 mm, more preferably from 0.2 to 1.5 mm and even more preferably from 0.5 to 1.0 mm. As methods for determining the average particle size of the granules, sieve analysis as described by CIPAC method MT 170-Dry Sieve Analysis of Water Dispersible Granules can be used.

The density of the granules at 20° C. is generally in the range of from 2 to 3 g/ml.

As methods for determining the density of the liquid droplets in the emulsion, the capsules or the granules, standard practices such as the pycnometer method or dynamic mechanical analysis (e.g. with a density meter DMA 4500 M from Anton Paar) as well as CIPAC method MT 3 can be used.

The application of the herbicidally effective amount of the herbicide A or of the composition comprising the herbicide A to the aquatic environment (in particular a flooded rice field or paddy) can be accomplished by any means that deliver the herbicide A to the water surface or directly into the water body of the aquatic environment (in particular a flooded rice field or paddy) such that the herbicide A becomes dispersed in the total water volume of the aquatic environment (in particular a flooded rice field or paddy) and settles into the weed germination zone.

In a preferred embodiment, a herbicidally effective amount of the herbicide A or of the composition comprising the herbicide A is applied into the water or onto the water surface of the aquatic environment (in particular a flooded rice field or paddy), more preferably onto the water surface of the aquatic environment (in particular a flooded rice field or paddy). Even more preferably, a herbicidally effective amount of an emulsifiable concentrate (EC) comprising the herbicide A being diluted with water, a capsule suspension (CS) comprising the herbicide A being optionally diluted with water or granules (GR) comprising the herbicide A (more preferably a herbicidally effective amount of a capsule suspension (CS) comprising the herbicide A being optionally diluted with water or granules (GR) comprising the herbicide A and most preferably a herbicidally effective amount of a capsule suspension (CS) comprising the herbicide A being optionally diluted with water) is applied into the water or onto the water surface of the aquatic environment (in particular a flooded rice field or paddy), in particular onto the water surface of the aquatic environment (in particular a flooded rice field or paddy). Still more preferably, a herbicidally effective amount of an emulsion obtained from diluting an emulsifiable concentrate (EC) comprising the herbicide A with water, a capsule suspension (CS) comprising the herbicide A, a dilute aqueous suspension obtained from diluting a capsule suspension (CS) comprising the herbicide A with water or granules (GR) comprising the herbicide A (more preferably a herbicidally effective amount of a capsule suspension (CS) comprising the herbicide A, a dilute aqueous suspension obtained from diluting a capsule suspension (CS) comprising the herbicide A with water or granules (GR) comprising the herbicide A and most preferably a herbicidally effective amount of a capsule suspension (CS) comprising the herbicide A or a dilute aqueous suspension obtained from diluting a capsule suspension (CS) comprising the herbicide A with water) is applied into the water or onto the water surface of the aquatic environment (in particular a flooded rice field or paddy), more preferably onto the water surface of the aquatic environment (in particular a flooded rice field or paddy).

In another preferred embodiment, a herbicidally effective amount of the herbicide A or of the composition comprising the herbicide A is applied by water-injection treatment, in-water treatment, or application onto the water surface of the aquatic environment (in particular a flooded rice field or paddy), more preferably by application onto the water surface of the aquatic environment (in particular a flooded rice field or paddy). Even more preferably, a herbicidally effective amount of an emulsifiable concentrate (EC) comprising the herbicide A being diluted with water, a capsule suspension (CS) comprising the herbicide A being optionally diluted with water or granules (GR) comprising the herbicide A (more preferably a herbicidally effective amount of a capsule suspension (CS) comprising the herbicide A being optionally diluted with water or granules (GR) comprising the herbicide A and most preferably a herbicidally effective amount of a capsule suspension (CS) comprising the herbicide A being optionally diluted with water) is applied by water-injection treatment, in-water treatment, or application onto the water surface of the aquatic environment (in particular a flooded rice field or paddy), more preferably by application onto the water surface of the aquatic environment (in particular a flooded rice field or paddy). Still more preferably, a herbicidally effective amount of an emulsion obtained from diluting an emulsifiable concentrate (EC) comprising the herbicide A with water, a capsule suspension (CS) comprising the herbicide A, a dilute aqueous suspension obtained from diluting a capsule suspension (CS) comprising the herbicide A with water or granules (GR) comprising the herbicide A (more preferably a herbicidally effective amount of a capsule suspension (CS) comprising the herbicide A, a dilute aqueous suspension obtained from diluting a capsule suspension (CS) comprising the herbicide A with water or granules (GR) comprising the herbicide A and most preferably a herbicidally effective amount of a capsule suspension (CS) comprising the herbicide A or a dilute aqueous suspension obtained from diluting a capsule suspension (CS) comprising the herbicide A with water) is applied by water injection treatment, in-water treatment, or application onto the water surface of the aquatic environment (in particular a flooded rice field or paddy), more preferably by application onto the water surface of the aquatic environment (in particular a flooded rice field or paddy).

In yet another preferred embodiment, the method of this invention comprises spraying a herbicidally effective amount of an emulsion obtained from diluting an emulsifiable concentrate (EC) comprising the herbicide A with water, a capsule suspension (CS) comprising the herbicide A, a dilute aqueous suspension obtained from diluting a capsule suspension (CS) comprising the herbicide A with water (preferably a capsule suspension (CS) comprising the herbicide A or a dilute aqueous suspension obtained from diluting a capsule suspension (CS) comprising the herbicide A with water), or broadcasting or adding a herbicidally effective amount of granules (GR) comprising the herbicide A into the water or onto the water surface of the aquatic environment (in particular a flooded rice field or paddy), more preferably onto the water surface of the aquatic environment (in particular a flooded rice field or paddy).

The application of a herbicidally effective amount of the herbicide A or of the composition comprising the herbicide A (preferably of an emulsion obtained from diluting an emulsifiable concentrate (EC) comprising the herbicide A with water, a capsule suspension (CS) comprising the herbicide A, a dilute aqueous suspension obtained from diluting a capsule suspension (CS) comprising the herbicide A with water or granules (GR) comprising the herbicide A, more preferably of a capsule suspension (CS) comprising the herbicide A, a dilute aqueous suspension obtained from diluting a capsule suspension (CS) comprising the herbicide A with water or granules (GR) comprising the herbicide A and most preferably of a capsule suspension (CS) comprising the herbicide A or a dilute aqueous suspension obtained from diluting a capsule suspension (CS) comprising the herbicide A with water) can be accomplished by the use of conventional ground or aerial dusters, sprayers, granule applicators including aerial (unmanned drone, airplane and helicopter) applications methods and by other conventional means known to those skilled in the art.

Application rates useful with the method described herein can be from 0.0001 to 10 kilograms active ingredient (i.e., the herbicide A) per hectare (kg ai/ha), preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha. Additional examples of useful application rates include, but are not limited to, less than or equal to 10 kg ai/ha, less than or equal to 7 kg ai/ha, less than or equal to 5 kg ai/ha, less than or equal to 3 kg ai/ha, less than or equal to 2 kg ai/ha, less than or equal to 1 kg ai/ha and less than or equal to 0.5 kg ai/ha.

In another preferred embodiment, bensulfuron-methyl or the composition comprising bensulfuron-methyl is applied at rates of 0.1 to 2 kilograms of active ingredient per hectare (kg ai/ha), more preferably 0.5 to 1.5 kg ai/ha and in particular 0.75 to 1.25 kg ai/ha.

In another preferred embodiment, benzobicyclon or the composition comprising benzobicyclon is applied at rates of 0.1 to 1 kilograms of active ingredient per hectare (kg ai/ha), more preferably 0.1 to 0.75 kg ai/ha and in particular 0.2 to 0.5 kg ai/ha.

In another preferred embodiment, bispyribac-sodium or the composition comprising bispyribac-sodium is applied at rates of 0.1 to 1 kilograms of active ingredient per hectare (kg ai/ha), more preferably 0.2 to 0.75 kg ai/ha, even more preferably 0.3 to 0.6 kg ai/ha and in particular 0.35 to 0.55 kg ai/ha.

In another preferred embodiment, carfentrazone-ethyl or the composition comprising carfentrazone-ethyl is applied at rates of 0.001 to 0.1 kilograms of active ingredient per hectare (kg ai/ha), more preferably 0.005 to 0.8 kg ai/ha and in particular 0.008 to 0.07 kg ai/ha.

In another preferred embodiment, cinmethylin or the composition comprising cinmethylin is applied at rates of 0.001 to 2 kilograms of active ingredient per hectare (kg ai/ha), more preferably 0.01 to 1 kg ai/ha, even more preferably 0.01 to 0.75 kg ai/ha, yet more preferably 0.01 to 0.5 kg ai/ha and in particular 0.1 to 0.5 kg ai/ha.

In another preferred embodiment, clomazone or the composition comprising clomazone is applied at rates of 0.05 to 1.5 kilograms of active ingredient per hectare (kg ai/ha), more preferably 0.1 to 1 kg ai/ha and in particular 0.25 to 0.9 kg ai/ha.

In another preferred embodiment, cyhalofop-butyl or the composition comprising cyhalofop-butyl is applied at rates of 0.1 to 1 kilograms of active ingredient per hectare (kg ai/ha), more preferably 0.2 to 0.5 kg ai/ha and in particular 0.25 to 0.35 kg ai/ha.

In another preferred embodiment, dimethenamid-P or the composition comprising dimethenamid-P is applied at rates of 0.1 to 2 kilograms of active ingredient per hectare (kg ai/ha), more preferably 0.2 to 1.5 kg ai/ha and in particular 0.5 to 1.2 kg ai/ha.

In another preferred embodiment, halosulfuron-methyl or the composition comprising halosulfuron-methyl is applied at rates of 0.001 to 0.2 kilograms of active ingredient per hectare (kg ai/ha), more preferably 0.01 to 0.15 kg ai/ha and in particular 0.02 to 0.12 kg ai/ha.

In another preferred embodiment, metolachlor or the composition comprising metolachlor is applied at rates of 0.5 to 2.5 kilograms of active ingredient per hectare (kg ai/ha), more preferably 0.75 to 2 kg ai/ha and in particular 0.8 to 1.85 kg ai/ha.

In another preferred embodiment, S-metolachlor or the composition comprising S-metolachlor is applied at rates of 0.5 to 3 kilograms of active ingredient per hectare (kg ai/ha), more preferably 0.75 to 2.5 kg ai/ha and in particular 1 to 2.2 kg ai/ha.

In another preferred embodiment, orthosulfamuron or the composition comprising orthosulfamuron is applied at rates of 0.1 to 1 kilograms of active ingredient per hectare (kg ai/ha), more preferably 0.2 to 0.75 kg ai/ha and in particular 0.3 to 0.5 kg ai/ha.

In another preferred embodiment, penoxsulam or the composition comprising penoxsulam is applied at rates of 0.001 to 0.1 kilograms of active ingredient per hectare (kg ai/ha), more preferably 0.01 to 0.075 kg ai/ha and in particular 0.03 to 0.05 kg ai/ha.

In another preferred embodiment, propanil or the composition comprising propanil is applied at rates of 1 to 10 kilograms of active ingredient per hectare (kg ai/ha), more preferably 2 to 8 kg ai/ha and in particular 3 to 7 kg ai/ha.

In another preferred embodiment, pyroxasulfone or the composition comprising pyroxasulfone is applied at rates of 0.001 to 1 kilograms of active ingredient per hectare (kg ai/ha), more preferably 0.01 to 0.5 kg ai/ha and in particular 0.03 to 0.35 kg ai/ha.

In another preferred embodiment, saflufenacil or the composition comprising saflufenacil is applied at rates of 0.01 to 0.5 kilograms of active ingredient per hectare (kg ai/ha), more preferably 0.02 to 0.2 kg ai/ha, 0.025 to 0.150 kg ai/ha, even more preferably 0.050 to 0.100 kg ai/ha and in particular 0.075 to 0.100 kg ai/ha.

In another preferred embodiment, thiobencarb or the composition comprising thiobencarb is applied at rates of 1 to 5 kilograms of active ingredient per hectare (kg ai/ha), more preferably 2 to 4 kg ai/ha and in particular 2.5 to 3.5 kg ai/ha.

In another preferred embodiment, triclopyr-choline or the composition comprising triclopyr-choline is applied at rates of 0.5 to 2.5 kilograms of active ingredient per hectare (kg ai/ha), more preferably 0.75 to 2.25 kg ai/ha and in particular 0.8 to 2 kg ai/ha.

The rice plant is selected from Oryza spp. such as Oryza sativa L. and Oryza glaberrima, most preferably Oryza sativa L. In another embodiment, the rice plant is selected from flooded dry-seeded, drill-seeded, wet-seeded, water-seeded and transplanted rice.

The method described herein are also suitable to control undesirable vegetation in herbicide-tolerant rice, in particular glyphosate-tolerant-, glufosinate-tolerant-, dicamba-tolerant-, phenoxy auxin-tolerant-, pyridyloxy auxin-tolerant-, aryloxyphenoxypropionate-tolerant-, acetyl CoA carboxylase (ACCase) inhibitor-tolerant-, imidazolinone-tolerant-, acetolactate synthase (ALS) inhibitor-tolerant-, 4-hydroxyphenyl-pyruvate dioxygenase (HPPD) inhibitor-tolerant-, protoporphyrinogen oxidase (PPO) inhibitor-tolerant-, triazine-tolerant-, and bromoxynil-tolerant-rice. Examples of commercialized herbicide-tolerant rice include quizalofop-P-ethyl-tolerant Provisia™ rice and imazamox-tolerant Clearfield® rice (both from BASF).

Although different varieties develop at different rates, and environmental factors strongly affect the duration of the different growth stages, the growth stages are well characterized, and defined on the rice in the BBCH monograph “Growth stages of mono- and dicotyledonous plants”, 2^{nd} edition, 2001, ed. Uwe Meier, Federal Biological Research Centre for Agriculture and Forestry (Biologische Bundesanstalt für Land-und Forstwirtschaft). The BBCH scale provides a system for a uniform coding of phenologically similar growth stages of plants. The early BBCH principal growth stages for rice, i.e. 0 (Germination) and 1 (Leaf development) are shown in the table below.

| | |
|---|---|
| Code | Description |

Principal growth stage 0: Germination

| | |
|---|---|
| 00 | Dry seed (caryopsis) |
| 01 | Beginning of seed imbibition |
| 03 | Seed imbibition complete (pigeon-breast) |
| 05 | Radicle emerged from caryopsis |
| 06 | Radicle elongated, root hairs and/or side roots visible |
| 07 | Coleoptile emerged from caryopsis (in water-rice |
| | this stage occurs before stage 05) |
| 09 | Imperfect leaf emerges (still rolled) at the tip of the coleoptile |

Principal growth stage 1: Leaf development

| | |
|---|---|
| 10 | Imperfect leaf unrolled, tip of first true leaf visible |
| 11 | First leaf unfolded |
| 12 | 2 leaves unfolded |
| 13 | 3 leaves unfolded |
| 14 | 4 leaves unfolded |
| 15 | 5 leaves unfolded |
| 16 | 6 leaves unfolded |
| 17 | 7 leaves unfolded |
| 18 | 8 leaves unfolded |
| 19 | 9 or more leaves unfolded |

In the method of this invention, a herbicidally effective amount of the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) can generally be applied at any pre-harvest stage after the germination of the rice seedlings. In a preferred embodiment of the method of this invention, a herbicidally effective amount of the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) or of the composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) is applied from the 2-leaf to the 9-leaf growth stage of the rice seedlings (BBCH Code 12 to 19), more preferably from the 2-leaf to the 6-leaf growth stage of the rice seedlings (BBCH Code 12 to 16) and even more preferably from the 4-leaf to the 6-leaf growth stage of the rice seedlings (BBCH Code 14 to 16).

In another preferred embodiment of the method of this invention, a herbicidally effective amount of the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) or of the composition comprising the herbicide A as defined herein (preferably selected from clomazone dimethenamid-P, metolachlor, S-metolachlor, pyroxasulfone and saflufenacil, more preferably selected from clomazone, metolachlor, S-metolachlor and saflufenacil and in particular saflufenacil) is applied from the 2-leaf to the 4-leaf growth stage of the rice seedlings (BBCH Code 12 to 14).

In another embodiment of this invention, a herbicidally effective amount of the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) or of the composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) is applied at the 2-leaf growth stage of the rice seedlings (BBCH Code 12). In another embodiment, a herbicidally effective amount of the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) or of the composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) is applied at the 3-leaf growth stage of the rice seedlings (BBCH Code 13). In another embodiment, a herbicidally effective amount of the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) or of the composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) is applied at the 4-leaf growth stage of the rice seedlings (BBCH Code 14). In another embodiment, a herbicidally effective amount of the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) or of the composition comprising the herbicide A as defined herein (preferably selected from clomazone dimethenamid-P, metolachlor, S-metolachlor, pyroxasulfone and saflufenacil, more preferably selected from clomazone, metolachlor, S-metolachlor and saflufenacil and in particular saflufenacil) is applied at the 5-leaf growth stage of the rice seedlings (BBCH Code 15). In another embodiment, a herbicidally effective amount of the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) or of the composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) is applied at the 6-leaf growth stage of the rice seedlings (BBCH Code 16). In another embodiment, a herbicidally effective amount of the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) or of the composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) is applied at the 7-leaf growth stage of the rice seedlings (BBCH Code 17). In another embodiment, a herbicidally effective amount of the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) or of the composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) is applied at the 8-leaf growth stage of the rice seedlings (BBCH Code 18). In another embodiment, a herbicidally effective amount of the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) is applied at the 9-leaf or more growth stage of the rice seedlings (BBCH Code 19).

In yet another preferred embodiment, a herbicidally effective amount of the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) or of the composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) is applied from 5 to 15 days, more preferably 5 to 10 days and even more preferably from 7 to 10 days after the rice seeds have been sown or after the rice plants have been transplanted.

In still another preferred embodiment, a herbicidally effective amount of the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) or of the composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) is applied from 5 to 15 days, more preferably 5 to 10 days and even more preferably from 7 to 10 days after the rice seeds have been sown or after the rice plants have been transplanted at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha.

In yet another preferred embodiment, a herbicidally effective amount of saflufenacil or of the composition comprising saflufenacil is applied from 5 to 15 days, more preferably 5 to 10 days and even more preferably from 7 to 10 days after the rice seeds have been sown or after the rice plants have been transplanted at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha.

The method of the present invention are suitable for controlling a large number of undesirable vegetation (harmful plants) including monocotyledonous weeds (in particular grasses, sedges and rushes) and dicotyledonous (broadleaf) weeds.

Exemplary monocotyledonous weeds that can be controlled by the method of this invention are selected from the genera Aegilops, Avena, Brachiaria, Bromus, Cenchrus, Chloris, Cyperus, Dactyloctenium, Digitaria, Echinochloa, Eleusine, Eriochloa, Leptochloa, Lolium, Panicum, Phalaris, Poa, Rottboellia, Setaria, Sorghum and Urochloa. Preferably, the undesirable vegetation is a monocotyledonous weed species selected from the genera Cyperus, Echinochloa and Leptochloa. More preferably, the undesirable vegetation is a monocotyledonous weed species selected from the genera Echinochloa and Leptochloa. In particular, the undesirable vegetation is a monocotyledonous weed species selected from the genus Echinochloa. In another particularly preferred embodiment, the undesirable vegetation is a monocotyledonous weed species selected from the genus Leptochloa.

Specific examples of monocotyledonous weed species that can be controlled by the method of this invention are selected from Aegilops cylindrical (AEGCY, jointed goatgrass), Avena fatua (AVEFA, wild oat), Brachiaria platyphylla (BRAPP, broadleaf signalgrass), Brachiaria texana (PANTA, Texas panicum), Bromus commutato (BROCO, hairy chess), Bromus japonicus (BROJA, Japanese brome), Bromus secalinus (BROSE, cheat), Bromus tectorum (BROTE, downy brome), Cenchrus spinifex (CCHPA, field sandbur), Chloris barbata (CHRBA, swollen fingergrass), Cyperus difformis (CYPDI, small-flower umbrella sedge), Cyperus eragrostis (CYPER, lovegrass sedge), Dactyloctenium aegyptium (DTTAE, crowfoot grass), Digitaria sanguinalis (DIGSA, large crabgrass), Echinochloa colonum (ECHCO, jungle rice), Echinochloa crus-galli (ECHCG, common barnyard grass), Echinochloa muricata (ECHPU, prickly barnyardgrass), Echinochloa muricata var. microstachya (ECHCM, rough barnyardgrass), Echinochloa oryzicola (ECHCR, late watergrass), Echinochloa oryzoides (ECHOR, early watergrass), Echinochloa walteri (ECHWA, water millet), Eleusine indica (ELEIN, goosegrass), Eriochloa villosa (ERBVI, woolly cupgrass), Leptochloa fusca subsp. uninervia (LEFUN, Mexican sprangletop), Leptochloa fusca subsp. fascicularis (LEFFA, bearded sprangletop), Lolium multiflorum (LOLMU, Italian ryegrass), Lolium rigidum (LOLRI, annual ryegrass), Panicum capillare (PANCA, witchgrass), Panicum dichotomiflorum (PANDI, fall panicum), Panicum miliaceum (PANMI, wild proso millet), Phalaris canariensis (PHACA, canarygrass), Poa annua (POAAN, annual bluegrass), Rottboellia cochinchinensis (ROOEX, itch grass), Setaria faberi (SETFA, giant foxtail), Setaria pumila (SETPU, yellow foxtail), Setaria viridis (SETVI, green foxtail), Sorghum halepense (SORHA, Johnson grass), Sorghum×drummondii (SORSU, shattercane), Urochloa fusca (PANFA, browntop panicum) and Urochloa maxima (PANMA, guineagrass).

Preferably, the undesirable vegetation is a monocotyledonous weed species selected from Cyperus difformis (CYPDI, small-flower umbrella sedge), Echinochloa colonum (ECHCO, jungle rice), Echinochloa crus-galli (ECHCG, common barnyard grass), Echinochloa muricata (ECHPU, prickly barnyardgrass), Echinochloa muricata var. microstachya (ECHCM, rough barnyardgrass), Echinochloa oryzicola (ECHCR, late watergrass), Echinochloa oryzoides (ECHOR, early watergrass), Echinochloa walteri (ECHWA, water millet), Leptochloa fusca subsp. uninervia (LEFUN, Mexican sprangletop), and Leptochloa fusca subsp. fascicularis (LEFFA, bearded sprangletop). More preferably, the undesirable vegetation is a monocotyledonous weed species selected from Cyperus difformis (CYPDI, small-flower umbrella sedge), Echinochloa crus-galli (ECHCG, common barnyard grass), Echinochloa muricata (ECHPU, prickly barnyardgrass), Echinochloa oryzicola (ECHCR, late watergrass), Echinochloa oryzoides (ECHOR, early watergrass), Leptochloa fusca subsp. uninervia (LEFUN, Mexican sprangletop), and Leptochloa fusca subsp. fascicularis (LEFFA, bearded sprangletop). Even more preferably, the undesirable vegetation is a monocotyledonous weed species selected from Cyperus difformis (CYPDI, small-flower umbrella sedge), Echinochloa crus-galli (ECHCG, common barnyard grass), Echinochloa oryzicola (ECHCR, late watergrass), and Leptochloa fusca subsp. fascicularis (LEFFA, bearded sprangletop). Yet more preferably, the undesirable vegetation is a monocotyledonous weed species selected from Echinochloa crusgalli (ECHCG, common barnyard grass), Echinochloa oryzicola (ECHCR, late watergrass), and Leptochloa fusca subsp. fascicularis (LEFFA, bearded sprangletop). In particular, the undesirable vegetation is Echinochloa crus-galli (ECHCG, common barnyard grass). In another particularly preferred embodiment, the undesirable vegetation is Leptochloa fusca subsp. fascicularis (LEFFA, bearded sprangletop).

Exemplary dicotyledonous or broadleaf weeds that can be controlled by the method of this invention are selected from the genera Abutilon, Amaranthus, Ammannia, Amsinckia, Anchusa, Bacopa, Barbarea, Bassia, Brassica, Calandrinia, Capsella, Chamaesyce, Chenopodium, Cuscuta, Erodium, Heteranthera, Ipomoea, Lactuca, Lamium, Mollugo, Persicaria, Polygonum, Pontederia, Portulaca, Richardia, Schoenoplectiella, Senecio, Sida, Sinapis, Sisymbrium, Solanum, Stellaria and Tribulus. Preferably, the undesirable vegetation is a dicotyledonous or broadleaf weed species selected from the genera Ammannia, Bacopa, Heteranthera, Pontederia, and Schoenoplectiella. More preferably, the undesirable vegetation is a dicotyledonous or broadleaf weed species selected from the genus Ammannia.

Specific examples of dicotyledonous or broadleaf weeds that can be controlled by the method of this invention are selected from Abutilon theophrasti (ABUTH, velvet leaf), Amaranthus palmeri (AMAPA, Palmer amaranth), Amaranthus retroflexus (AMARE, pigweed), Amaranthus tuberculatus (AMATU, tall waterhemp), Ammannia auriculata (AMMAU, redstem), Ammannia coccinea (AMMCO, purple redstem), Amsinckia menziesii (ANSME, fiddleneck), Anchusa arvensis (LYCAR, small bugloss), Bacopa monnieri (BAOMO, Monnier water hyssop), Barbarea vulgaris (BARVU, bittercress), Bassia scoparia (KCHSC, kochia), Brassica nigra (BRSNI, black mustard), Calandrinia ciliata subsp. menziesii (CLNCM, redmaids rock purslane), Capsella bursa-pastoris (CAPBP, shepherd's purse), Chamaesyce maculata (EPHMA, annual spurge), Chenopodium album (CHEAL, common lambsquarters), Chenopodium leptophyllum (CHELE, slimleaf lambsquarters), Cuscuta europaea (CVCAU, large dodder), Erodium cicutarium (EROCI, redstem filaree), Heteranthera limosa (HETLI, duck salad), Ipomoea hederacea (IPOHE, morningglory), Lactuca serriola (LACSE, prickly lettuce), Lamium amplexicaule (LAMAM, henbit), Mollugo verticillata (MOLVE, carpetweed), Persicaria maculosa (POLPE, ladysthumb), Persicaria pensylvanica (POLPY, Pennsylvania smartweed), Polygonum aviculare (POLAV, prostrate knotweed), Pontederia vaginalis (MOOVA, monochoria), Portulaca oleracea (POROL, purslane), Richardia scabra (RCHSC, Florida pusley), Schoenoplectiella mucronata (SCPMU, rice-field bulrush), Senecio vulgaris (SENVU, common groundsel), Sida spinosa (SIDSP, prickly sida), Sinapis arvensis (SINAR, wild mustard), Sisymbrium irio (SSYIR, London rocket), Solanum nigrum (SOLNI, black nightshade), Stellaria media (STEME, common chickweed) and Tribulus terrestris (TRBTE, common puncturevine).

Preferably, the undesirable vegetation is a dicotyledonous or broadleaf weed species selected from Ammannia auriculata (AMMAU, redstem), Ammannia coccinea (AMMCO, purple redstem), Bacopa monnieri (BAOMO, Monnier water hyssop), Heteranthera limosa (HETLI, duck salad), Pontederia vaginalis (MOOVA, monochoria), and Schoenoplectiella mucronata (SCPMU, rice-field bulrush). More preferably, the undesirable vegetation is Ammannia auriculata (AMMAU, redstem) or Ammannia coccinea (AMMCO, purple redstem). In one especially preferred embodiment, the undesirable vegetation is Ammannia auriculata (AMMAU, redstem). In another especially preferred embodiment, the undesirable vegetation is Ammannia coccinea (AMMCO, purple redstem).

In another preferred embodiment, the undesirable vegetation is selected from the genera Aegilops, Avena, Brachiaria, Bromus, Cenchrus, Chloris, Cyperus, Dactyloctenium, Digitaria, Echinochloa, Eleusine, Eriochloa, Leptochloa, Lolium, Panicum, Phalaris, Poa, Rottboellia, Setaria, Sorghum, Urochloa, Abutilon, Amaranthus, Ammannia, Amsinckia, Anchusa, Bacopa, Barbarea, Bassia, Brassica, Calandrinia, Capsella, Chamaesyce, Chenopodium, Cuscuta, Erodium, Heteranthera, Ipomoea, Lactuca, Lamium, Mollugo, Persicaria, Polygonum, Pontederia, Portulaca, Richardia, Schoenoplectiella, Senecio, Sida, Sinapis, Sisymbrium, Solanum, Stellaria and Tribulus. More preferably, the undesirable vegetation is selected from the genera Cyperus, Echinochloa, Leptochloa, Ammannia, Bacopa, Heteranthera, Pontederia, and Schoenoplectiella. Even more preferably, the undesirable vegetation is selected from the genera Cyperus, Echinochloa, Leptochloa and Ammannia. In particular, the undesirable vegetation is selected from the genera Echinochloa and Leptochloa. Most preferably, the undesirable vegetation is selected from the genus Echinochloa. In another particularly preferred embodiment, the undesirable vegetation is selected from the genus Leptochloa.

In yet another especially preferred embodiment, the undesirable vegetation is selected from the genera Cyperus, Echinochloa, Leptochloa, Ammannia, Bacopa, Heteranthera and Schoenoplectiella, m Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

In yet another preferred embodiment, the undesirable vegetation is selected from Aegilops cylindrical (AEGCY, jointed goatgrass), Avena fatua (AVEFA, wild oat), Brachiaria platyphylla (BRAPP, broadleaf signalgrass), Brachiaria texana (PANTA, Texas panicum), Bromus commutato (BROCO, hairy chess), Bromus japonicus (BROJA, Japanese brome), Bromus secalinus (BROSE, cheat), Bromus tectorum (BROTE, downy brome), Cenchrus spinifex (CCHPA, field sandbur), Chloris barbata (CHRBA, swollen fingergrass), Cyperus difformis (CYPDI, small-flower umbrella sedge), Cyperus eragrostis (CYPER, lovegrass sedge), Dactyloctenium aegyptium (DTTAE, crowfoot grass), Digitaria sanguinalis (DIGSA, large crabgrass), Echinochloa colonum (ECHCO, jungle rice), Echinochloa crus-galli (ECHCG, common barnyard grass), Echinochloa muricata (ECHPU, prickly barnyardgrass), Echinochloa muricata var. microstachya (ECHCM, rough barnyardgrass), Echinochloa oryzicola (ECHCR, late watergrass), Echinochloa oryzoides (ECHOR, early watergrass), Echinochloa walteri (ECHWA, water millet), Eleusine indica (ELEIN, goosegrass), Eriochloa villosa (ERBVI, woolly cupgrass), Leptochloa fusca subsp. uninervia (LEFUN, Mexican sprangletop), Leptochloa fusca subsp. fascicularis (LEFFA, bearded sprangletop), Lolium multiflorum (LOLMU, Italian ryegrass), Lolium rigidum (LOLRI, annual ryegrass), Panicum capillare (PANCA, witchgrass), Panicum dichotomiflorum (PANDI, fall panicum), Panicum miliaceum (PANMI, wild proso millet), Phalaris canariensis (PHACA, canarygrass), Poa annua (POAAN, annual bluegrass), Rottboellia cochinchinensis (ROOEX, itch grass), Setaria faberi (SETFA, giant foxtail), Setaria pumila (SETPU, yellow foxtail), Setaria viridis (SETVI, green foxtail), Sorghum halepense (SORHA, Johnson grass), Sorghum×drummondii (SORSU, shattercane), Urochloa fusca (PANFA, browntop panicum) and Urochloa maxima (PANMA, guineagrass), Abutilon theophrasti (ABUTH, velvet leaf), Amaranthus palmeri (AMAPA, Palmer amaranth), Amaranthus retroflexus (AMARE, pigweed), Amaranthus tuberculatus (AMATU, tall waterhemp), Ammannia auriculata (AMMAU, redstem), Ammannia coccinea (AMMCO, purple redstem), Amsinckia menziesii (ANSME, fiddleneck), Anchusa arvensis (LYCAR, small bugloss), Bacopa monnieri (BAOMO, Monnier water hyssop), Barbarea vulgaris (BARVU, bittercress), Bassia scoparia (KCHSC, kochia), Brassica nigra (BRSNI, black mustard), Calandrinia ciliata subsp. menziesii (CLNCM, redmaids rock purslane), Capsella bursa-pastoris (CAPBP, shepherd's purse), Chamaesyce maculata (EPHMA, annual spurge), Chenopodium album (CHEAL, common lambsquarters), Chenopodium leptophyllum (CHELE, slimleaf lambsquarters), Cuscuta europaea (CVCAU, large dodder), Erodium cicutarium (EROCI, redstem filaree), Heteranthera limosa (HETLI, duck salad), Ipomoea hederacea (IPOHE, morningglory), Lactuca serriola (LACSE, prickly lettuce), Lamium amplexicaule (LAMAM, henbit), Mollugo verticillata (MOLVE, carpetweed), Persicaria maculosa (POLPE, ladysthumb), Persicaria pensylvanica (POLPY, Pennsylvania smartweed), Polygonum aviculare (POLAV, prostrate knotweed), Pontederia vaginalis (MOOVA, monochoria), Portulaca oleracea (POROL, purslane), Richardia scabra (RCHSC, Florida pusley), Schoenoplectiella mucronata (SCPMU, rice-field bulrush), Senecio vulgaris (SENVU, common groundsel), Sida spinosa (SIDSP, prickly sida), Sinapis arvensis (SINAR, wild mustard), Sisymbrium irio (SSYIR, London rocket), Solanum nigrum (SOLNI, black nightshade), Stellaria media (STEME, common chickweed) and Tribulus terrestris (TRBTE, common puncturevine).

More preferably, the undesirable vegetation is selected from Cyperus difformis (CYPDI, small-flower umbrella sedge), Echinochloa colonum (ECHCO, jungle rice), Echinochloa crus-galli (ECHCG, common barnyard grass), Echinochloa muricata (ECHPU, prickly barnyardgrass), Echinochloa muricata var. microstachya (ECHCM, rough barnyardgrass), Echinochloa oryzicola (ECHCR, late watergrass), Echinochloa oryzoides (ECHOR, early watergrass), Echinochloa walteri (ECHWA, water millet), Leptochloa fusca subsp. uninervia (LEFUN, Mexican sprangletop), Leptochloa fusca subsp. fascicularis (LEFFA, bearded sprangletop), Ammannia auriculata (AMMAU, redstem), Ammannia coccinea (AMMCO, purple redstem), Bacopa monnieri (BAOMO, Monnier water hyssop), Heteranthera limosa (HETLI, duck salad), Pontederia vaginalis (MOOVA, monochoria), and Schoenoplectiella mucronata (SCPMU, rice-field bulrush).

Even more preferably, the undesirable vegetation is selected from Cyperus difformis (CYPDI, small-flower umbrella sedge), Echinochloa crus-galli (ECHCG, common barnyard grass), Echinochloa muricata (ECHPU, prickly barnyardgrass), Echinochloa oryzicola (ECHCR, late watergrass), Echinochloa oryzoides (ECHOR, early watergrass), Leptochloa fusca subsp. uninervia (LEFUN, Mexican sprangletop), Leptochloa fusca subsp. fascicularis (LEFFA, bearded sprangletop), Ammannia auriculata (AMMAU, redstem), Ammannia coccinea (AMMCO, purple redstem), Bacopa monnieri (BAOMO, Monnier water hyssop), Heteranthera limosa (HETLI, duck salad), Pontederia vaginalis (MOOVA, monochoria), and Schoenoplectiella mucronata (SCPMU, rice-field bulrush).

Still more preferably, the undesirable vegetation is selected from Cyperus difformis (CYPDI, small-flower umbrella sedge), Echinochloa crus-galli (ECHCG, common barnyard grass), Echinochloa oryzicola (ECHCR, late watergrass), Leptochloa fusca subsp. fascicularis (LEFFA, bearded sprangletop), Ammannia auriculata (AMMAU, redstem), Bacopa monnieri (BAOMO, Monnier water hyssop), Heteranthera limosa (HETLI, duck salad), Pontederia vaginalis (MOOVA, monochoria), and Schoenoplectiella mucronata (SCPMU, rice-field bulrush).

In another especially preferred embodiment, the undesirable vegetation is selected from Cyperus difformis (CYPDI, small-flower umbrella sedge), Echinochloa crus-galli (ECHCG, common barnyard grass), Echinochloa muricata (ECHPU, prickly barnyardgrass), Echinochloa oryzicola (ECHCR, late watergrass), Echinochloa oryzoides (ECHOR, early watergrass), Leptochloa fusca subsp. uninervia (LEFUN, Mexican sprangletop), Leptochloa fusca subsp. fascicularis (LEFFA, bearded sprangletop), and Ammannia coccinea (AMMCO, purple redstem), more preferably selected from Echinochloa crus-galli (ECHCG, common barnyard grass), Echinochloa muricata (ECHPU, prickly barnyardgrass), Echinochloa oryzicola (ECHCR, late watergrass), Echinochloa oryzoides (ECHOR, early watergrass), Leptochloa fusca subsp. uninervia (LEFUN, Mexican sprangletop), Leptochloa fusca subsp. fascicularis (LEFFA, bearded sprangletop), even more preferably selected from Echinochloa crus-galli (ECHCG, common barnyard grass), Echinochloa oryzicola (ECHCR, late watergrass) and Leptochloa fusca subsp. fascicularis (LEFFA, bearded sprangletop).

In yet another especially preferred embodiment, the undesirable vegetation is selected from Cyperus difformis (CYPDI, small-flower umbrella sedge), Cyperus eragrostis (CYPER, lovegrass sedge), Echinochloa colonum (ECHCO, jungle rice), Echinochloa crus-galli (ECHCG, common barnyard grass), Echinochloa muricata (ECHPU, prickly barnyardgrass), Echinochloa muricata var. microstachya (ECHCM, rough barnyardgrass), Echinochloa oryzicola (ECHCR, late watergrass), Echinochloa oryzoides (ECHOR, early watergrass), Echinochloa walteri (ECHWA, water millet), Ammannia auriculata (AMMAU, redstem), Ammannia coccinea (AMMCO, purple redstem), Bacopa monnieri (BAOMO, Monnier water hyssop), Heteranthera limosa (HETLI, duck salad) and Schoenoplectiella mucronata (SCPMU, rice-field bulrush), more preferably selected from Cyperus difformis (CYPDI, small-flower umbrella sedge), Echinochloa crus-galli (ECHCG, common barnyard grass), Echinochloa oryzicola (ECHCR, late watergrass), Ammannia auriculata (AMMAU, redstem), Bacopa monnieri (BAOMO, Monnier water hyssop), Heteranthera limosa (HETLI, duck salad) and Schoenoplectiella mucronata (SCPMU, rice-field bulrush), even more preferably selected from Cyperus difformis (CYPDI, small-flower umbrella sedge), Ammannia auriculata (AMMAU, redstem), Bacopa monnieri (BAOMO, Monnier water hyssop), Heteranthera limosa (HETLI, duck salad) and Schoenoplectiella mucronata (SCPMU, rice-field bulrush), yet more preferably selected from Ammannia auriculata (AMMAU, redstem), Bacopa monnieri (BAOMO, Monnier water hyssop), Heteranthera limosa (HETLI, duck salad) and Schoenoplectiella mucronata (SCPMU, rice-field bulrush) and in particular selected from Ammannia auriculata (AMMAU, redstem), Bacopa monnieri (BAOMO, Monnier water hyssop) and Heteranthera limosa (HETLI, duck salad).

In another embodiment, the undesirable vegetation is a herbicide resistant or tolerant weed species.

Exemplary herbicide resistant or tolerant weed species include, but are not limited to, biotypes resistant or tolerant to herbicides selected from the group consisting of acetyl CoA carboxylase (ACCase) inhibitors (HRAC Group A), acetolactate synthase (ALS) inhibitors (HRAC Group B), photosystem II (PS II) inhibitors (HRAC Groups C1, C2 and C3), DOXP synthase inhibitors (HRAC Group F4), and very long chain fatty acid (VLCFA) inhibitors (HRAC Group K3).

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of microcapsules or solid particles.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of microcapsules.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of solid particles.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A being optionally diluted with water or granules (GR) comprising the herbicide A.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A being optionally diluted with water.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is granules (GR) comprising the herbicide A.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A, a dilute aqueous suspension obtained from diluting a capsule suspension (CS) comprising the herbicide A with water or granules (GR) comprising the herbicide A.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A or a dilute aqueous suspension obtained from diluting a capsule suspension (CS) comprising the herbicide A with water.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of microcapsules or solid particles and applied at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of microcapsules and applied at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of solid particles and applied at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A being optionally diluted with water or granules (GR) comprising the herbicide A and the application rate is from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A being optionally diluted with water and the application rate is from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is granules (GR) comprising the herbicide A and the application rate is from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A, a dilute aqueous suspension obtained from diluting a capsule suspension (CS) comprising the herbicide A with water or granules (GR) comprising the herbicide A and the application rate is from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A or a dilute aqueous suspension obtained from diluting a capsule suspension (CS) comprising the herbicide A with water and the application rate is from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein saflufenacil is present in the composition in the form of microcapsules or solid particles and applied at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein saflufenacil is present in the composition in the form of microcapsules and applied at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein saflufenacil is present in the composition in the form of solid particles and applied at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein the composition is a capsule suspension (CS) comprising saflufenacil being optionally diluted with water, a suspension concentrate (SC) comprising saflufenacil being diluted with water or granules (GR) comprising saflufenacil and the application rate is from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein the composition is a capsule suspension (CS) comprising saflufenacil being optionally diluted with water and the application rate is from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein the composition is a suspension concentrate (SC) comprising saflufenacil being diluted with water and the application rate is from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein the composition is a capsule suspension (CS) comprising saflufenacil, a dilute aqueous suspension obtained from diluting a capsule suspension (CS) comprising saflufenacil with water, a suspension concentrate (SC) comprising saflufenacil being diluted with water or granules (GR) comprising saflufenacil and the application rate is from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein the composition is a capsule suspension (CS) comprising saflufenacil or a dilute aqueous suspension obtained from diluting a capsule suspension (CS) comprising saflufenacil with water and the application rate is from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of microcapsules or solid particles and applied from 5 to 15 days, more preferably 5 to 10 days and even more preferably from 7 to 10 days after the rice seeds have been sown or after the rice plants have been transplanted.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of microcapsules and is applied from 5 to 15 days, more preferably 5 to 10 days and even more preferably from 7 to 10 days after the rice seeds have been sown or after the rice plants have been transplanted.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of solid particles and is applied from 5 to 15 days, more preferably 5 to 10 days and even more preferably from 7 to 10 days after the rice seeds have been sown or after the rice plants have been transplanted.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A being optionally diluted with water or granules (GR) comprising the herbicide A and is applied from 5 to 15 days, more preferably 5 to 10 days and even more preferably from 7 to 10 days after the rice seeds have been sown or after the rice plants have been transplanted.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A being optionally diluted with water and is applied from 5 to 15 days, more preferably 5 to 10 days and even more preferably from 7 to 10 days after the rice seeds have been sown or after the rice plants have been transplanted.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is granules (GR) comprising the herbicide A and is applied from 5 to 15 days, more preferably 5 to 10 days and even more preferably from 7 to 10 days after the rice seeds have been sown or after the rice plants have been transplanted.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A, a dilute aqueous suspension obtained from diluting a capsule suspension (CS) comprising the herbicide A with water or granules (GR) comprising the herbicide A and is applied from 5 to 15 days, more preferably 5 to 10 days and even more preferably from 7 to 10 days after the rice seeds have been sown or after the rice plants have been transplanted.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A or a dilute aqueous suspension obtained from diluting a capsule suspension (CS) comprising the herbicide A with water and is applied from 5 to 15 days, more preferably 5 to 10 days and even more preferably from 7 to 10 days after the rice seeds have been sown or after the rice plants have been transplanted.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of microcapsules or solid particles and applied from 5 to 15 days, more preferably 5 to 10 days and even more preferably from 7 to 10 days after the rice seeds have been sown or after the rice plants have been transplanted at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of microcapsules and applied from 5 to 15 days, more preferably 5 to 10 days and even more preferably from 7 to 10 days after the rice seeds have been sown or after the rice plants have been transplanted at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of solid particles and applied from 5 to 15 days, more preferably 5 to 10 days and even more preferably from 7 to 10 days after the rice seeds have been sown or after the rice plants have been transplanted at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A being optionally diluted with water or granules (GR) comprising the herbicide A and applied from 5 to 15 days, more preferably 5 to 10 days and even more preferably from 7 to 10 days after the rice seeds have been sown or after the rice plants have been transplanted at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A being optionally diluted with water and applied from 5 to 15 days, more preferably 5 to 10 days and even more preferably from 7 to 10 days after the rice seeds have been sown or after the rice plants have been transplanted at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is granules (GR) comprising the herbicide A and applied from 5 to 15 days, more preferably 5 to 10 days and even more preferably from 7 to 10 days after the rice seeds have been sown or after the rice plants have been transplanted at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A, a dilute aqueous suspension obtained from diluting a capsule suspension (CS) comprising the herbicide A with water or granules (GR) comprising the herbicide A and applied from 5 to 15 days, more preferably 5 to 10 days and even more preferably from 7 to 10 days after the rice seeds have been sown or after the rice plants have been transplanted at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A or a dilute aqueous suspension obtained from diluting a capsule suspension (CS) comprising the herbicide A with water and applied from 5 to 15 days, more preferably 5 to 10 days and even more preferably from 7 to 10 days after the rice seeds have been sown or after the rice plants have been transplanted at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein saflufenacil is present in the composition in the form of microcapsules or solid particles and applied from 5 to 15 days, more preferably 5 to 10 days and even more preferably from 7 to 10 days after the rice seeds have been sown or after the rice plants have been transplanted at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein saflufenacil is present in the composition in the form of microcapsules and applied from 5 to 15 days, more preferably 5 to 10 days and even more preferably from 7 to 10 days after the rice seeds have been sown or after the rice plants have been transplanted at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein saflufenacil is present in the composition in the form of solid particles and applied from 5 to 15 days, more preferably 5 to 10 days and even more preferably from 7 to 10 days after the rice seeds have been sown or after the rice plants have been transplanted at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein the composition is a capsule suspension (CS) comprising saflufenacil being optionally diluted with water, a suspension concentrate (SC) comprising saflufenacil being diluted with water or granules (GR) comprising saflufenacil and applied from 5 to 15 days, more preferably 5 to 10 days and even more preferably from 7 to 10 days after the rice seeds have been sown or after the rice plants have been transplanted at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein the composition is a capsule suspension (CS) comprising saflufenacil being optionally diluted with water and applied from 5 to 15 days, more preferably 5 to 10 days and even more preferably from 7 to 10 days after the rice seeds have been sown or after the rice plants have been transplanted at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein the composition is a suspension concentrate (SC) comprising saflufenacil being diluted with water and applied from 5 to 15 days, more preferably 5 to 10 days and even more preferably from 7 to 10 days after the rice seeds have been sown or after the rice plants have been transplanted at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein the composition is a capsule suspension (CS) comprising saflufenacil, a dilute aqueous suspension obtained from diluting a capsule suspension (CS) comprising saflufenacil with water, a suspension concentrate (SC) comprising saflufenacil being diluted with water or granules (GR) comprising saflufenacil and applied from 5 to 15 days, more preferably 5 to 10 days and even more preferably from 7 to 10 days after the rice seeds have been sown or after the rice plants have been transplanted at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein the composition is a capsule suspension (CS) comprising saflufenacil or a dilute aqueous suspension obtained from diluting a capsule suspension (CS) comprising saflufenacil with water and applied from 5 to 15 days, more preferably 5 to 10 days and even more preferably from 7 to 10 days after the rice seeds have been sown or after the rice plants have been transplanted at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of microcapsules or solid particles and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of microcapsules and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of solid particles and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A being optionally diluted with water or granules (GR) comprising the herbicide A and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A being optionally diluted with water and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is granules (GR) comprising the herbicide A and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A, a dilute aqueous suspension obtained from diluting a capsule suspension (CS) comprising the herbicide A with water or granules (GR) comprising the herbicide A and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A or a dilute aqueous suspension obtained from diluting a capsule suspension (CS) comprising the herbicide A with water and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of microcapsules or solid particles and applied at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of microcapsules and applied at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of solid particles and applied at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A being optionally diluted with water or granules (GR) comprising the herbicide A and the application rate is from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A being optionally diluted with water and the application rate is from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is granules (GR) comprising the herbicide A and the application rate is from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A, a dilute aqueous suspension obtained from diluting a capsule suspension (CS) comprising the herbicide A with water or granules (GR) comprising the herbicide A and the application rate is from 1 to 5 kg ai/ha, preferably from 1 to 4 kg ai/ha, more preferably from 1 to 3 kg ai/ha and in particular from 1 to 2.5 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A or a dilute aqueous suspension obtained from diluting a capsule suspension (CS) comprising the herbicide A with water and the application rate is from 1 to 5 kg ai/ha, preferably from 1 to 4 kg ai/ha, more preferably from 1 to 3 kg ai/ha and in particular from 1 to 2.5 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein saflufenacil is present in the composition in the form of microcapsules or solid particles and applied at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein saflufenacil is present in the composition in the form of microcapsules and applied at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein saflufenacil is present in the composition in the form of solid particles and applied at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein the composition is a capsule suspension (CS) comprising saflufenacil being optionally diluted with water, a suspension concentrate (SC) comprising saflufenacil being diluted with water or granules (GR) comprising saflufenacil and the application rate is from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein the composition is a capsule suspension (CS) comprising saflufenacil being optionally diluted with water and the application rate is from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein the composition is a suspension concentrate (SC) comprising saflufenacil being diluted with water and the application rate is from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of microcapsules or solid particles and applied from 5 to 15 days, more preferably 5 to 10 days and even more preferably from 7 to 10 days after the rice seeds have been sown or after the rice plants have been transplanted and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of microcapsules and is applied from 5 to 15 days, more preferably 5 to 10 days and even more preferably from 7 to 10 days after the rice seeds have been sown or after the rice plants have been transplanted and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of solid particles and is applied from 5 to 15 days, more preferably 5 to 10 days and even more preferably from 7 to 10 days after the rice seeds have been sown or after the rice plants have been transplanted and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A being optionally diluted with water or granules (GR) comprising the herbicide A and is applied from 5 to 15 days, more preferably 5 to 10 days and even more preferably from 7 to 10 days after the rice seeds have been sown or after the rice plants have been transplanted and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A being optionally diluted with water and is applied from 5 to 15 days, more preferably 5 to 10 days and even more preferably from 7 to 10 days after the rice seeds have been sown or after the rice plants have been transplanted and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is granules (GR) comprising the herbicide A and is applied from 5 to 15 days, more preferably 5 to 10 days and even more preferably from 7 to 10 days after the rice seeds have been sown or after the rice plants have been transplanted and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A, a dilute aqueous suspension obtained from diluting a capsule suspension (CS) comprising the herbicide A with water or granules (GR) comprising the herbicide A and is applied from 5 to 15 days, more preferably 5 to 10 days and even more preferably from 7 to 10 days after the rice seeds have been sown or after the rice plants have been transplanted and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A or a dilute aqueous suspension obtained from diluting a capsule suspension (CS) comprising the herbicide A with water and is applied from 5 to 15 days, more preferably 5 to 10 days and even more preferably from 7 to 10 days after the rice seeds have been sown or after the rice plants have been transplanted and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of microcapsules or solid particles and applied from 5 to 15 days, more preferably 5 to 10 days and even more preferably from 7 to 10 days after the rice seeds have been sown or after the rice plants have been transplanted at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of microcapsules and applied from 5 to 15 days, more preferably 5 to 10 days and even more preferably from 7 to 10 days after the rice seeds have been sown or after the rice plants have been transplanted at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the herbicide A is present in the composition in the form of solid particles and applied from 5 to 15 days, more preferably 5 to 10 days and even more preferably from 7 to 10 days after the rice seeds have been sown or after the rice plants have been transplanted at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A being optionally diluted with water or granules (GR) comprising the herbicide A and applied from 5 to 15 days, more preferably 5 to 10 days and even more preferably from 7 to 10 days after the rice seeds have been sown or after the rice plants have been transplanted at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A being optionally diluted with water and applied from 5 to 15 days, more preferably 5 to 10 days and even more preferably from 7 to 10 days after the rice seeds have been sown or after the rice plants have been transplanted at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is granules (GR) comprising the herbicide A and applied from 5 to 15 days, more preferably 5 to 10 days and even more preferably from 7 to 10 days after the rice seeds have been sown or after the rice plants have been transplanted at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A, a dilute aqueous suspension obtained from diluting a capsule suspension (CS) comprising the herbicide A with water or granules (GR) comprising the herbicide A and applied from 5 to 15 days, more preferably 5 to 10 days and even more preferably from 7 to 10 days after the rice seeds have been sown or after the rice plants have been transplanted at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) pre-emergence or early post-emergence of the undesirable vegetation and after germination of the rice seedlings wherein the composition is a capsule suspension (CS) comprising the herbicide A or a dilute aqueous suspension obtained from diluting a capsule suspension (CS) comprising the herbicide A with water and applied from 5 to 15 days, more preferably 5 to 10 days and even more preferably from 7 to 10 days after the rice seeds have been sown or after the rice plants have been transplanted at an application rate of from 0.0001 to 10 kg ai/ha, preferably 0.001 to 7 kg ai/ha, more preferably 0.001 to 5 kg ai/ha, even more preferably 0.01 to 3 kg ai/ha, yet more preferably 0.01 to 2 kg ai/ha, still more preferably 0.01 to 1 kg ai/ha and in particular 0.01 to 0.5 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein saflufenacil is present in the composition in the form of microcapsules or solid particles and applied from 5 to 15 days, more preferably 5 to 10 days and even more preferably from 7 to 10 days after the rice seeds have been sown or after the rice plants have been transplanted at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein saflufenacil is present in the composition in the form of microcapsules and applied from 5 to 15 days, more preferably 5 to 10 days and even more preferably from 7 to 10 days after the rice seeds have been sown or after the rice plants have been transplanted at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein saflufenacil is present in the composition in the form of solid particles and applied from 5 to 15 days, more preferably 5 to 10 days and even more preferably from 7 to 10 days after the rice seeds have been sown or after the rice plants have been transplanted at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein the composition is a capsule suspension (CS) comprising saflufenacil being optionally diluted with water, a suspension concentrate (SC) comprising saflufenacil being diluted with water or granules (GR) comprising saflufenacil and applied from 5 to 15 days, more preferably 5 to 10 days and even more preferably from 7 to 10 days after the rice seeds have been sown or after the rice plants have been transplanted at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein the composition is a capsule suspension (CS) comprising saflufenacil being optionally diluted with water and applied from 5 to 15 days, more preferably 5 to 10 days and even more preferably from 7 to 10 days after the rice seeds have been sown or after the rice plants have been transplanted at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein the composition is a suspension concentrate (SC) comprising saflufenacil being diluted with water and applied from 5 to 15 days, more preferably 5 to 10 days and even more preferably from 7 to 10 days after the rice seeds have been sown or after the rice plants have been transplanted at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein the composition is a capsule suspension (CS) comprising saflufenacil, a dilute aqueous suspension obtained from diluting a capsule suspension (CS) comprising saflufenacil with water, a suspension concentrate (SC) comprising saflufenacil being diluted with water or granules (GR) comprising saflufenacil and applied from 5 to 15 days, more preferably 5 to 10 days and even more preferably from 7 to 10 days after the rice seeds have been sown or after the rice plants have been transplanted at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

Another preferred embodiment of this invention relates to a method for controlling undesirable vegetation in an aquatic environment in which a rice plant is growing, said method comprising applying to the aquatic environment a herbicidally effective amount of a composition comprising saflufenacil pre-emergence or early post-emergence of the undesirable vegetation and after germination of the rice seedlings wherein the composition is a capsule suspension (CS) comprising saflufenacil or a dilute aqueous suspension obtained from diluting a capsule suspension (CS) comprising saflufenacil with water and applied from 5 to 15 days, more preferably 5 to 10 days and even more preferably from 7 to 10 days after the rice seeds have been sown or after the rice plants have been transplanted at an application rate of from 0.01 to 0.5 kg ai/ha, preferably 0.02 to 0.2 kg ai/ha, 0.025 to 0.150 kg ai/ha, more preferably 0.050 to 0.100 kg ai/ha and in particular 0.075 to 0.100 kg ai/ha and the undesirable vegetation is selected from the genera Cyperus, Echinochloa, Leptochloa, Ammannia, Bacopa, Heteranthera and Schoenoplectiella, preferably selected from the genera Cyperus, Echinochloa, Ammannia, Bacopa, Heteranthera and Schoenoplectiella, more preferably selected from the genera Cyperus, Ammannia, Bacopa, Heteranthera and Schoenoplectiella, even more preferably selected from the genera Ammannia, Bacopa, Heteranthera and Schoenoplectiella and in particular selected from the genera Ammannia, Bacopa and Heteranthera.

In one embodiment of the method of this invention, a herbicidally effective amount of the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) as the sole herbicidally active ingredient is applied.

In another embodiment, the method of this invention may comprise applying at least one further herbicide B (as defined herein). As used herein, the terms “at least one further herbicide B”, “at least one herbicide B” or “herbicide B” exclude the herbicide A as defined herein. In yet another embodiment, a herbicidally effective amount of a composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) and at least one further herbicide B (as defined hereinafter) is applied.

In a preferred embodiment, the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) is applied in combination with at least one further herbicide B selected from the groups b1) to b15):
b1) lipid biosynthesis inhibitors;
b2) acetolactate synthase inhibitors (ALS inhibitors);
b3) photosynthesis inhibitors;
b4) protoporphyrinogen-IX oxidase inhibitors,
b5) bleacher herbicides;
b6) enolpyruvyl shikimate 3-phosphate synthase inhibitors (EPSP inhibitors);
b7) glutamine synthetase inhibitors;
b8) 7,8-dihydropteroate synthase inhibitors (DHP inhibitors);
b9) mitosis inhibitors;
b10) inhibitors of the synthesis of very long chain fatty acids (VLCFA inhibitors);
b11) cellulose biosynthesis inhibitors;
b12) decoupler herbicides;
b13) auxinic herbicides;
b14) auxin transport inhibitors; and
b15) other herbicides selected from the group consisting of bromobutide, chlorflurenol, chlorflurenol-methyl, cumyluron, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, indaziflam, maleic hydrazide, mefluidide, metam, methiozolin, methyl azide, methyl bromide, methyl-dymron, methyl iodide, oleic acid, oxaziclomefone, pelargonic acid, pyributicarb, quinoclamine, triaziflam, tridiphane and 6-chloro-3-(2-cyclopropyl-6-methylphenoxy)-4-pyridazinol (CAS 499223-49-3) and its salts and esters;
   and agriculturally acceptable salts or derivatives thereof.

In another embodiment, the herbicide A as defined herein or the composition comprising the herbicide A as defined herein is applied in combination with at least one further herbicide B selected from lipid biosynthesis inhibitors (group b1). These are compounds that inhibit lipid biosynthesis. Inhibition of the lipid biosynthesis can be affected either through inhibition of acetylCoA carboxylase (hereinafter termed ACC herbicides) or through a different mode of action (hereinafter termed non-ACC herbicides). The ACC herbicides belong to the group A of the HRAC classification system whereas the non-ACC herbicides belong to the group N of the HRAC classification.

In another embodiment, the herbicide A as defined herein or the composition comprising the herbicide A as defined herein is applied in combination with at least one further herbicide B selected from ALS inhibitors (group b2). The herbicidal activity of these compounds is based on the inhibition of acetolactate synthase and thus on the inhibition of the branched chain amino acid biosynthesis. These inhibitors belong to the group B of the HRAC classification system.

In another embodiment, the herbicide A as defined herein or the composition comprising the herbicide A as defined herein is applied in combination with at least one further herbicide B selected from photosynthesis inhibitors (group b3). The herbicidal activity of these compounds is based either on the inhibition of the photosystem II in plants (so-called PSII inhibitors, groups C1, C2 and C3 of HRAC classification) or on diverting the electron transfer in photosystem I in plants (so-called PSI inhibitors, group D of HRAC classification) and thus on an inhibition of photosynthesis.

In another embodiment, the herbicide A as defined herein or the composition comprising the herbicide A as defined herein is applied in combination with at least one further herbicide B selected from protoporphyrinogen-IX-oxidase inhibitors (group b4). The herbicidal activity of these compounds is based on the inhibition of the protoporphyrinogen-IX-oxidase. These inhibitors belong to the group E of the HRAC classification system.

In another embodiment, the herbicide A as defined herein or the composition comprising the herbicide A as defined herein is applied in combination with at least one further herbicide B selected from bleacher herbicides (group b5). The herbicidal activity of these compounds is based on the inhibition of the carotenoid biosynthesis. These include compounds which inhibit carotenoid biosynthesis by inhibition of phytoene desaturase (so-called PDS inhibitors, group F1 of HRAC classification), compounds that inhibit the 4-hydroxyphenylpyruvate-dioxygenase (HPPD inhibitors, group F2 of HRAC classification), compounds that inhibit DOXsynthase (group F4 of HRAC class) and compounds which inhibit carotenoid biosynthesis by an unknown mode of action (bleacher—unknown target, group F3 of HRAC classification).

In another embodiment, the herbicide A as defined herein or the composition comprising the herbicide A as defined herein is applied in combination with at least one further herbicide B selected from EPSP synthase inhibitors (group b6). The herbicidal activity of these compounds is based on the inhibition of enolpyruvyl shikimate 3-phosphate synthase, and thus on the inhibition of the amino acid biosynthesis in plants. These inhibitors belong to the group G of the HRAC classification system.

In another embodiment, the herbicide A as defined herein or the composition comprising the herbicide A as defined herein is applied in combination with at least one further herbicide B selected from glutamine synthetase inhibitors (group b7). The herbicidal activity of these compounds is based on the inhibition of glutamine synthetase, and thus on the inhibition of the aminoacid biosynthesis in plants. These inhibitors belong to the group H of the HRAC classification system.

In another embodiment, the herbicide A as defined herein or the composition comprising the herbicide A as defined herein is applied in combination with at least one further herbicide B selected from DHP synthase inhibitors (group b8). The herbicidal activity of these compounds is based on the inhibition of 7,8-dihydropteroate synthase. These inhibitors belong to the group I of the HRAC classification system.

In another embodiment, the herbicide A as defined herein or the composition comprising the herbicide A as defined herein is applied in combination with at least one further herbicide B selected from mitosis inhibitors (group b9). The herbicidal activity of these compounds is based on the disturbance or inhibition of microtubule formation or organization, and thus on the inhibition of mitosis. These inhibitors belong to the groups K1 and K2 of the HRAC classification system.

In another embodiment, the herbicide A as defined herein or the composition comprising the herbicide A as defined herein is applied in combination with at least one further herbicide B selected from VLCFA inhibitors (group b10). The herbicidal activity of these compounds is based on the inhibition of the synthesis of very long chain fatty acids and thus on the disturbance or inhibition of cell division in plants. These inhibitors belong to the group K3 of the HRAC classification system.

In another embodiment, the herbicide A as defined herein or the composition comprising the herbicide A as defined herein is applied in combination with at least one further herbicide B selected from cellulose biosynthesis inhibitors (group b11). The herbicidal activity of these compounds is based on the inhibition of the biosynthesis of cellulose and thus on the inhibition of the synthesis of cell walls in plants. These inhibitors belong to the group L of the HRAC classification system.

In another embodiment, the herbicide A as defined herein or the composition comprising the herbicide A as defined herein is applied in combination with at least one further herbicide B selected from decoupler herbicides (group b12). The herbicidal activity of these compounds is based on the disruption of the cell membrane. These inhibitors belong to the group M of the HRAC classification system.

In another embodiment, the herbicide A as defined herein or the composition comprising the herbicide A as defined herein is applied in combination with at least one further herbicide B selected from auxinic herbicides (group b13). These include compounds that mimic auxins, i.e. plant hormones, and affect the growth of the plants. These compounds belong to the group O of the HRAC classification system.

In another embodiment, the herbicide A as defined herein or the composition comprising the herbicide A as defined herein is applied in combination with at least one further herbicide B selected from auxin transport inhibitors (group b14). The herbicidal activity of these compounds is based on the inhibition of the auxin transport in plants. These compounds belong to the group P of the HRAC classification system.

As to the given mechanisms of action and classification of the active substances, see e.g. “HRAC, Classification of Herbicides According to Mode of Action”, http://www.plantprotection.org/hrac/MOA.html).

Examples of the at least one further herbicide B that can be applied in combination with the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) or the composition comprising the herbicide A as defined herein (preferably selected from clomazone, dimethenamid-P, metolachlor, S-metolachlor, pyroxasulfone and saflufenacil, more preferably selected from clomazone, metolachlor, S-metolachlor and saflufenacil and in particular saflufenacil) are selected from
b1) from the group of the lipid biosynthesis inhibitors:
ACC-herbicides such as alloxydim, alloxydim-sodium, butroxydim, cycloxydim, diclofop, diclofop-methyl, haloxyfop, haloxyfop-methyl, haloxyfop-P, haloxyfop-P-methyl, metamifop, profoxydim, propaquizafop, tepraloxydim, tralkoxydim, 4-(4′-Chloro-4-cyclopropyl-2′-fluoro[1,1′-biphenyl]-3-yl)-5-hydroxy-2,2,6,6-tetramethyl-2H-pyran-3(6H)-one (CAS 1312337-72-6); 4-(2′,4′-Dichloro-4-cyclopropyl[1,1′-biphenyl]-3-yl)-5-hydroxy-2,2,6,6-tetramethyl-2H-pyran-3(6H)-one (CAS 1312337-45-3); 4-(4′-Chloro-4-ethyl-2′-fluoro[1,1′-biphenyl]-3-yl)-5-hydroxy-2,2,6,6-tetramethyl-2H-pyran-3(6H)-one (CAS 1033757-93-5); 4-(2′,4′-Dichloro-4-ethyl[1,1′-biphenyl]-3-yl)-2,2,6,6-tetramethyl-2H-pyran-3,5(4H,6H)-dione (CAS 1312340-84-3); 5-(Acetyloxy)-4-(4′-chloro-4-cyclopropyl-2′-fluoro[1,1′-biphenyl]-3-yl)-3,6-dihydro-2,2,6,6-tetramethyl-2H-pyran-3-one (CAS 1312337-48-6); 5-(Acetyloxy)-4-(2′,4′-dichloro-4-cyclopropyl-[1,1′-biphenyl]-3-yl)-3,6-dihydro-2,2,6,6-tetramethyl-2H-pyran-3-one; 5-(Acetyloxy)-4-(4′-chloro-4-ethyl-2′-fluoro[1,1′-biphenyl]-3-yl)-3,6-dihydro-2,2,6,6-tetramethyl-2H-pyran-3-one (CAS 1312340-82-1); 5-(Acetyloxy)-4-(2′,4′-dichloro-4-ethyl[1,1′-biphenyl]-3-yl)-3,6-dihydro-2,2,6,6-tetramethyl-2H-pyran-3-one (CAS 1033760-55-2); 4-(4′-Chloro-4-cyclopropyl-2′-fluoro[1,1′-biphenyl]-3-yl)-5,6-dihydro-2,2,6,6-tetramethyl-5-oxo-2H-pyran-3-yl carbonic acid methyl ester (CAS 1312337-51-1); 4-(2′,4′-Dichloro-4-cyclopropyl-[1,1′-biphenyl]-3-yl)-5,6-dihydro-2,2,6,6-tetramethyl-5-oxo-2H-pyran-3-yl carbonic acid methyl ester; 4-(4′-Chloro-4-ethyl-2′-fluoro[1,1′-biphenyl]-3-yl)-5,6-dihydro-2,2,6,6-tetramethyl-5-oxo-2H-pyran-3-yl carbonic acid methyl ester (CAS 1312340-83-2); 4-(2′,4′-Dichloro-4-ethyl[1,1′-biphenyl]-3-yl)-5,6-dihydro-2,2,6,6-tetramethyl-5-oxo-2H-pyran-3-yl carbonic acid methyl ester (CAS 1033760-58-5); and non ACC herbicides such as benfuresate, dalapon, dimepiperate, esprocarb, flupropanate, molinate, orbencarb, pebulate, prosulfocarb, TCA, tiocarbazil and vernolate;
b2) from the group of the ALS inhibitors:
sulfonylureas such as amidosulfuron, azimsulfuron, cinosulfuron, cyclosulfamuron, ethametsulfuron, ethametsulfuron-methyl, ethoxysulfuron, flazasulfuron, flucetosulfuron, flupyrsulfuron, flupyrsulfuron-methyl-sodium, foramsulfuron, imazosulfuron, iofensulfuron, iofensulfuron-sodium, metazosulfuron, oxasulfuron, propyrisulfuron, prosulfuron, pyrazosulfuron, pyrazosulfuron-ethyl, sulfometuron, sulfometuron-methyl and tritosulfuron, imidazolinones such as imazamethabenz and imazamethabenz-methyl, triazolopyrimidine herbicides and sulfonanilides such as cloransulam, cloransulam-methyl, diclosulam, flumetsulam, florasulam, metosula and pyrimisulfan,
pyrimidinylbenzoates such as pyribenzoxim, pyriftalid, pyriminobac, pyriminobac-methyl, 4-[[[2-[(4,6-dimethoxy-2-pyrimidinyl)oxy]phenyl]methyl]amino]-benzoic acid-1-methylethyl ester (CAS 420138-41-6), 4-[[[2-[(4,6-dimethoxy-2-pyrimidinyl)oxy]phenyl]methyl]amino]-benzoic acid propyl ester (CAS 420138-40-5), N-(4-bromophenyl)-2-[(4,6-dimethoxy-2-pyrimidinyl)oxy]benzenemethanamine (CAS 420138-01-8), sulfonylaminocarbonyl-triazolinone herbicides such as flucarbazone, flucarbazone-sodium, propoxycarbazone, propoxycarbazone-sodium, thiencarbazone and thiencarbazone-methyl; and triafamone;
b3) from the group of the photosynthesis inhibitors:
amicarbazone, inhibitors of the photosystem II, e.g. 1-(6-tert-butylpyrimidin-4-yl)-2-hydroxy-4-methoxy-3-methyl-2H-pyrrol-5-one (CAS 1654744-66-7), 1-(5-tert-butylisoxazol-3-yl)-2-hydroxy-4-methoxy-3-methyl-2H-pyrrol-5-one (CAS 1637455-12-9), 1-(5-tert-butylisoxazol-3-yl)-4-chloro-2-hydroxy-3-methyl-2H-pyrrol-5-one (CAS 1637453-94-1), 1-(5-tert-butyl-1-methyl-pyrazol-3-yl)-4-chloro-2-hydroxy-3-methyl-2H-pyrrol-5-one (CAS 1654057-29-0), 1-(5-tert-butyl-1-methylpyrazol-3-yl)-3-chloro-2-hydroxy-4-methyl-2H-pyrrol-5-one (CAS 1654747-80-4), 4-hydroxy-1-methoxy-5-methyl-3-[4-(trifluoromethyl)-2-pyridyl]imidazolidin-2-one; (CAS 2023785-78-4), 4-hydroxy-1,5-dimethyl-3-[4-(trifluoromethyl)-2-pyridyl]imidazolidin-2-one (CAS 2023785-79-5), 5-ethoxy-4-hydroxy-1-methyl-3-[4-(trifluoromethyl)-2-pyridyl]imidazolidin-2-one (CAS 1701416-69-4), 4-hydroxy-1-methyl-3-[4-(trifluoromethyl)-2-pyridyl]imidazolidin-2-one (CAS 1708087-22-2), 4-hydroxy-1,5-dimethyl-3-[1-methyl-5-(trifluoromethyl)pyrazol-3-yl]imidazolidin-2-one (CAS 2023785-80-8), 1-(5-tert-butylisoxazol-3-yl)-4-ethoxy-5-hydroxy-3-methyl-imidazolidin-2-one (CAS 1844836-64-1), triazine herbicides, including of chlorotriazine, triazinones, triazindiones, methylthiotriazines and pyridazinones such as ametryn, atrazine, chloridazone, cyanazine, desmetryn, dimethametryn, hexazinone, metribuzin, prometon, prometryn, propazine, simazine, simetryn, terbumeton, terbuthylazin, terbutryn and trietazin, aryl urea such as chlorobromuron, chlorotoluron, chloroxuron, dimefuron, diuron, fluometuron, isoproturon, isouron, linuron, metamitron, methabenzthiazuron, metobenzuron, metoxuron, monolinuron, neburon, siduron, tebuthiuron and thiadiazuron, phenyl carbamates such as desmedipham, karbutilat, phenmedipham, phenmedipham-ethyl, nitrile herbicides such as bromofenoxim, bromoxynil and its salts and esters, ioxynil and its salts and esters, uraciles such as bromacil, lenacil and terbacil, and bentazon and bentazon-sodium, pyridate, pyridafol, pentanochlor and inhibitors of the photosystem I such as diquat, diquat-dibromide, paraquat, paraquat-dichloride and paraquat-dimetilsulfate;
b4) from the group of the protoporphyrinogen-IX oxidase inhibitors:
azafenidin, bencarbazone, benzfendizone, bifenox, butafenacil, chlomethoxyfen, chlorphthalim, cinidon-ethyl, cyclopyranil, fluazolate, flufenpyr, flufenpyr-ethyl, fluoroglycofen, fluoroglycofen-ethyl, halosafen, oxadiargyl, oxadiazon, oxyfluorfen, pentoxazone, profluazol, pyraclonil, pyraflufen, pyraflufen-ethyl, thidiazimin, ethyl [3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S3100), N-ethyl-3-(2,6-dichloro-4-trifluoromethylphenoxy)-5-methyl-1H-pyrazole-1-carboxamide (CAS 452098-92-9), N-tetrahydrofurfuryl-3-(2,6-dichloro-4-trifluoromethylphenoxy)-5-methyl-1H-pyrazole-1-carboxamide (CAS 915396-43-9), N-ethyl-3-(2-chloro-6-fluoro-4-trifluoromethylphenoxy)-5-methyl-1H-pyrazole-1-carboxamide (CAS 452099-05-7), N-tetrahydrofurfuryl-3-(2-chloro-6-fluoro-4-trifluoromethylphenoxy)-5-methyl-1H-pyrazole-1-carboxamide (CAS 452100-03-7), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione (CAS 451484-50-7), 2-(2,2,7-trifluoro-3-oxo-4-prop-2-ynyl-3,4-dihydro-2H-benzo[1,4]oxazin-6-yl)-4,5,6,7-tetrahydro-isoindole-1,3-dione (CAS 1300118-96-0), 1-methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione (CAS 1304113-05-0), methyl (E)-4-[2-chloro-5-[4-chloro-5-(difluoromethoxy)-1H-methyl-pyrazol-3-yl]-4-fluoro-phenoxy]-3-methoxy-but-2-enoate (CAS 948893-00-3), and 3-[7-chloro-5-fluoro-2-(trifluoromethyl)-1H-benzimidazol-4-yl]-1-methyl-6-(trifluoromethyl)-1H-pyrimidine-2,4-dione (CAS 212754-02-4), 2-[2-chloro-5-[3-chloro-5-(trifluoromethyl)-2-pyridinyl]-4-fluorophenoxy]-2-methoxy-acetic acid methyl ester (CAS 1970221-16-9), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-acetic acid methyl ester (CAS 2158274-96-3), 2-[2-[[3-chloro-6-[3,6-dihydro-3-methyl-2,6-dioxo-4-(trifluoromethyl)-1(2H)pyrimidinyl]-5-fluoro-2-pyridinyl]oxy]phenoxy] acetic acid ethyl ester (CAS 158274-50-9), methyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2271389-22-9), ethyl 2-[[3-[2-chloro-5-[4-(difluoromethyl)-3-methyl-5-oxo-1,2,4-triazol-1-yl]-4-fluoro-phenoxy]-2-pyridyl]oxy]acetate (CAS 2230679-62-4), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-acetic acid methyl ester (CAS 2158275-73-9), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy] acetic acid ethyl ester (CAS 2158274-56-5), 2-[2-[[3-chloro-6-[3,6-dihydro-3-methyl-2,6-dioxo-4-(trifluoromethyl)-1(2H)-pyrimidinyl]-5-fluoro-2-pyridinyl]oxy]phenoxy]-N(methylsulfonyl)-acetamide (CAS 2158274-53-2), 2-[[3-[[3-chloro-6-[3,6-dihydro-3-methyl-2,6-dioxo-4-(trifluoromethyl)-1(2H)-pyrimidinyl]-5-fluoro-2-pyridinyl]oxy]-2-pyridinyl]oxy]-N(methylsulfonyl)-acetamide (CAS 2158276-22-1);
b5) from the group of the bleacher herbicides:
PDS inhibitors: beflubutamid, diflufenican, fluridone, flurochloridone, flurtamone, norflurazon, picolinafen, and 4-(3-trifluoromethylphenoxy)-2-(4-trifluoromethylphenyl)pyrimidine (CAS 180608-33-7), HPPD inhibitors: benzofenap, fenquinotrione, oxotrione (CAS 1486617-21-3), pyrazolynate, pyrazoxyfen, sulcotrione, tefuryltrione, bleacher, unknown target: aclonifen, amitrole flumeturon,2-chloro-3-methylsulfanyl-N-(1-methyltetrazol-5-yl)-4-(trifluoromethyl)benzamide (CAS 1361139-71-0), bixlozone and 2-(2,5-dichlorophenyl)methyl-4,4-dimethyl-3-isoxazolidinone (CAS 81778-66-7);
b6) from the group of the EPSP synthase inhibitors:
glyphosate, glyphosate-isopropylammonium, glyphosate-potassium and glyphosate-trimesium (sulfosate);
b7) from the group of the glutamine synthase inhibitors:
bilanaphos (bialaphos), bilanaphos-sodium, glufosinate, glufosinate-P and glufosinate-ammonium;
b8) from the group of the DHP synthase inhibitors:
asulam;
b9) from the group of the mitosis inhibitors:
compounds of group K1: dinitroanilines such as benfluralin, butralin, dinitramine, fluchloralin, oryzalin, pendimethalin and prodiamine, phosphoramidates such as amiprophos, amiprophosmethyl, and butamiphos, benzoic acid herbicides such as chlorthal, chlorthal-dimethyl, pyridines such as thiazopyr, benzamides such as tebutam; compounds of group K2: carbetamide, chlorpropham, flamprop, flamprop-isopropyl, flamprop-methyl, flamprop-M-isopropyl, flamprop-M-methyl and propham;
b10) from the group of the VLCFA inhibitors:
chloroacetamides such as amidochlor, butachlor, dimethachlor, metazachlor, pethoxamid, pretilachlor, propachlor, propisochlor and thenylchlor, oxyacetanilides such as mefenacet, acetanilides such as diphenamid, naproanilide, napropamide and napropamide-M, tetrazolinones such fentrazamide, and other herbicides such as anilofos, cafenstrole, fenoxasulfone, ipfencarbazone, piperophos and isoxazoline compounds of the formulae II.1, II.2, II.3, II.4, II.5, II.6, II.7, II.8 and II.9

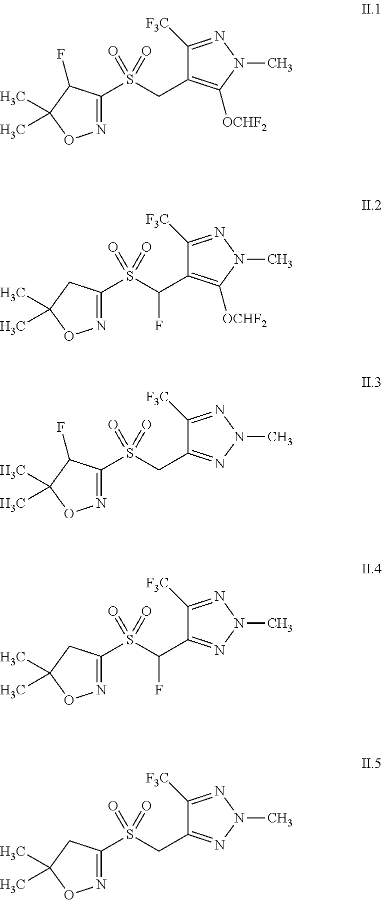

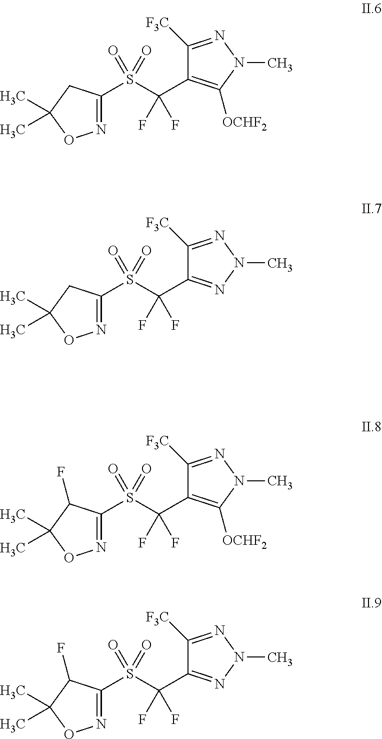

the isoxazoline compounds of the formula (II) are known in the art, e.g. from WO 2006/024820, WO 2006/037945, WO 2007/071900 and WO 2007/096576;
b11) from the group of the cellulose biosynthesis inhibitors:
chlorthiamid, dichlobenil, flupoxam, indaziflam, isoxaben, triaziflam and 1-cyclohexyl-5-pentafluorphenyloxy-1⁴-[1,2,4,6]thiatriazin-3-ylamine (CAS 175899-01-1);
b12) from the group of the decoupler herbicides:
dinoseb, dinoterb and DNOC and its salts;
b13) from the group of the auxinic herbicides:
2,4-DE and its salts and esters, aminocyclopyrachlor and its salts and esters, benazolin, benazolin-ethyl, chloramben and its salts and esters, clomeprop, dichlorprop and its salts and esters, dichlorprop-P and its salts and esters, MCPB and its salts and esters, mecoprop and its salts and esters, mecoprop-P and its salts and esters, picloram and its salts and esters, quinmerac, TBA (2,3,6) and its salts and esters and 4-amino-3-chloro-5-fluoro-6-(7-fluoro-1H-indol-6-yl)picolinic acid (CAS 1629965-65-6);
b14) from the group of the auxin transport inhibitors: naptalam and naptalam-sodium;
b15) from the group of the other herbicides: bromobutide, chlorflurenol, chlorflurenol-methyl, cumyluron, cyclopyrimorate (CAS 499223-49-3) and its salts and esters, dalapon, dazomet, difenzoquat, difenzoquat-metilsulfate, dimethipin, DSMA, dymron, endothal and its salts, etobenzanid, flurenol, flurenol-butyl, flurprimidol, fosamine, fosamine-ammonium, indanofan, maleic hydrazide, mefluidide, metam, methiozolin, methyl azide, methyl bromide, methyl-dymron, methyl iodide, oleic acid, oxaziclomefone, pelargonic acid, pyributicarb, quinoclamine, tetflupyrolimet and tridiphane.

In another embodiment, the method of this invention may further comprise applying at least one safener C (as defined herein). In yet another embodiment, the method of this invention may further comprise applying at least one further herbicide B (as defined herein) and at least one safener C (as defined herein). In yet another embodiment, a herbicidally effective amount of a composition comprising the herbicide A (as defined herein) and least one safener C (as defined herein) is applied. In still another embodiment, a herbicidally effective amount of a composition comprising the herbicide A (as defined herein), at least one further herbicide B (as defined herein) and at least one safener C (as defined herein) is applied.

Safeners are chemical compounds which prevent or reduce damage on useful plants without having a major impact on the herbicidal action of the herbicidal active components of the present compositions towards unwanted plants. They can be applied either before sowings (e.g. on seed treatments, shoots or seedlings) or in the pre-emergence application or post-emergence application of the useful plant. The safeners C and the herbicide A (as defined herein) and optionally the herbicides B can be applied simultaneously or in succession.

Suitable safeners are e.g. (quinolin-8-oxy)acetic acids, 1-phenyl-5-haloalkyl-1H-1,2,4-triazol-3-carboxylic acids, 1-phenyl-4,5-dihydro-5-alkyl-1H-pyrazol-3,5-dicarboxylic acids, 4,5-dihydro-5,5-diaryl-3-isoxazol carboxylic acids, dichloroacetamides, alpha-oximinophenylacetonitriles, acetophenonoximes, 4,6-dihalo-2-phenylpyrimidines, N-[[4-(aminocarbonyl)phenyl]sulfonyl]-2-benzoic amides, 1,8-naphthalic anhydride, 2-halo-4-(haloalkyl)-5-thiazol carboxylic acids, phosphorthiolates and N-alkyl-O-phenylcarbamates and their agriculturally acceptable salts and their agriculturally acceptable derivatives such amides, esters, and thioesters, provided they have an acid group.

Examples of preferred safeners C are benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthaleneacetic acid (NAA), naphthalic anhydride (NA), oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4), metcamifen, 4-bromophenyl chloromethyl sulfone (BPCMS, CAS 54091-06-4) and agriculturally acceptable salts or derivatives thereof.

Especially preferred safeners C are benoxacor, cloquintocet, cyprosulfamide, dichlormid, fenchlorazole, fenclorim, flurazole, fluxofenim, furilazole, isoxadifen, mefenpyr, naphthalic anhydride (NAA), oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and metcamifen.

Particularly preferred safeners C are benoxacor, cloquintocet, cyprosulfamide, dichlormid, fenchlorazole, fenclorim, furilazole, isoxadifen, mefenpyr, naphtalic anhydride, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4) and metcamifen.

The herbicides A, herbicides B of groups b1) to b15) and the safeners C as described herein are known herbicides and safeners, see, for example, The Compendium of Pesticide Common Names (https://pesticidecompendium.bcpc.org); Farm Chemicals Handbook 2000 volume 86, Meister Publishing Company, 2000; B. Hock, C. Fedtke, R. R. Schmidt, Herbizide [Herbicides], Georg Thieme Verlag, Stuttgart 1995; W. H. Ahrens, Herbicide Handbook, 7th edition, Weed Science Society of America, 1994; and K. K. Hatzios, Herbicide Handbook, Supplement for the 7th edition, Weed Science Society of America, 1998. 2,2,5-Trimethyl-3-(dichloroacetyl)-1,3-oxazolidine [CAS No. 52836-31-4] is also referred to as R-29148. 4-(Dichloroacetyl)-1-oxa-4-azaspiro[4.5]decane [CAS No. 71526-07-3] is also referred to as AD-67 and MON 4660.

The assignment of the active compounds to the respective mechanisms of action is based on current knowledge. If several mechanisms of action apply to one active compound, this substance was only assigned to one mechanism of action.

If the herbicides A, herbicides B and/or the safeners C as described herein are capable of forming geometrical isomers, for example E/Z isomers, it is possible to use both, the pure isomers and mixtures thereof, in the method according to the invention.

If the herbicides A, herbicides B and/or the safeners C as described herein have one or more centers of chirality and, as a consequence, are present as enantiomers or diastereomers, it is possible to use both, the pure enantiomers and diastereomers and their mixtures, in the method according to the invention.

If the herbicides A, herbicides B and/or the safeners C as described herein have ionizable functional groups, they can also be employed in the form of their agriculturally acceptable salts. Suitable are, in general, the salts of those cations and the acid addition salts of those acids whose cations and anions, respectively, have no adverse effect on the activity of the active compounds.

Preferred cations are the ions of the alkali metals, preferably of lithium, sodium and potassium, of the alkaline earth metals, preferably of calcium and magnesium, and of the transition metals, preferably of manganese, copper, zinc and iron, further ammonium and substituted ammonium in which one to four hydrogen atoms are replaced by C₁-C₄-alkyl, hydroxy-C₁-C₄-alkyl, C₁-C₄-alkoxy-C₁-C₄-alkyl, hydroxy-C₁-C₄-alkoxy-C₁-C₄-alkyl, phenyl or benzyl, preferably ammonium, methylammonium, isopropylammonium, dimethylammonium, diethylammonium, diisopropylammonium, trimethylammonium, triethylammonium, tris(isopropyl)ammonium, heptylammonium, dodecylammonium, tetradecylammonium, tetramethylammonium, tetraethylammonium, tetrabutylammonium, 2-hydroxyethylammonium (olamine salt), 2-(2-hydroxyeth-1-oxy)eth-1-ylammonium (diglycolamine salt), di(2-hydroxyeth-1-yl)ammonium (diolamine salt), tris(2-hydroxyethyl)ammonium (trolamine salt), tris(2-hydroxypropyl)ammonium, benzyltrimethylammonium, benzyltriethylammonium, N,N,N-trimethylethanolammonium (choline salt), furthermore phosphonium ions, sulfonium ions, preferably tri(C₁-C₄-alkyl)sulfonium, such as trimethylsulfonium, and sulfoxonium ions, preferably tri(C₁-C₄-alkyl)sulfoxonium, and finally the salts of polybasic amines such as N,N-bis(3-aminopropyl)methylamine and diethylenetriamine.

Anions of useful acid addition salts are primarily chloride, bromide, fluoride, iodide, hydrogensulfate, methylsulfate, sulfate, dihydrogenphosphate, hydrogenphosphate, nitrate, bicarbonate, carbonate, hexafluorosilicate, hexafluorophosphate, benzoate and also the anions of C₁-C₄-alkanoic acids, preferably formate, acetate, propionate and butyrate.

Herbicides A, herbicides B and/or safeners C as described herein having a carboxyl group can be employed in the form of the acid, in the form of an agriculturally suitable salt as mentioned above or else in the form of an agriculturally acceptable derivative, for example as amides, such as mono- and di-C₁-C₆-alkylamides or arylamides, as esters, for example as allyl esters, propargyl esters, C₁-C₁₀-alkyl esters, alkoxyalkyl esters, tefuryl ((tetrahydrofuran-2-yl)methyl) esters and also as thioesters, for example as C₁-C₁₀-alkylthio esters. Preferred mono- and di-C₁-C₆-alkylamides are the methyl and the dimethylamides. Preferred arylamides are, for example, the anilides and the 2-chloroanilides. Preferred alkyl esters are, for example, the methyl, ethyl, propyl, isopropyl, butyl, isobutyl, pentyl, mexyl (1-methylhexyl), meptyl (1-methylheptyl), heptyl, octyl or isooctyl (2-ethylhexyl) esters. Preferred C₁-C₄-alkoxy-C₁-C₄-alkyl esters are the straight-chain or branched C₁-C₄-alkoxy ethyl esters, for example the 2-methoxyethyl, 2-ethoxyethyl, 2-butoxyethyl (butotyl), 2-butoxypropyl or 3-butoxypropyl ester. An example of a straight-chain or branched C₁-C₁₀-alkylthio ester is the ethylthio ester.

In the case of dicamba, suitable salts include those, where the counterion is an agriculturally acceptable cation. For example, suitable salts of dicamba are dicamba-sodium, dicamba-potassium, dicamba-methylammonium, dicamba-dimethylammonium, dicamba-isopropylammonium, dicamba-diglycolamine, dicamba-olamine, dicamba-diolamine, dicamba-trolamine, dicamba-N,N-bis-(3-aminopropyl)methylamine and dicamba-diethylenetriamine. Examples of a suitable ester are dicamba-methyl and dicamba-butotyl.

Suitable salts of 2,4-D are 2,4-D-ammonium, 2,4-D-dimethylammonium, 2,4-D-diethylammonium, 2,4-D-diethanolammonium (2,4-D-diolamine), 2,4-D-triethanolammonium, 2,4-D-isopropylammonium, 2,4-D-triisopropanolammonium, 2,4-D-heptylammonium, 2,4-D-dodecylammonium, 2,4-D-tetradecylammonium, 2,4-D-triethylammonium, 2,4-D-tris(2-hydroxypropyl)ammonium, 2,4-D-tris(isopropyl)ammonium, 2,4-D-trolamine, 2,4-D-lithium, 2,4-D-sodium and 2,4-D-N,N,N-trimethylethanolammonium (2,4-D choline). Examples of suitable esters of 2,4-D are 2,4-D-butotyl, 2,4-D-2-butoxypropyl, 2,4-D-3-butoxypropyl, 2,4-D-butyl, 2,4-D-ethyl, 2,4-D-ethylhexyl, 2,4-D-isobutyl, 2,4-D-isooctyl, 2,4-D-isopropyl, 2,4-D-meptyl, 2,4-D-methyl, 2,4-D-octyl, 2,4-D-pentyl, 2,4-D-propyl, 2,4-D-tefuryl and clacyfos.

Suitable salts of 2,4-DB are for example 2,4-DB-sodium, 2,4-DB-potassium and 2,4-DB-dimethylammonium. Suitable esters of 2,4-DB are for example 2,4-DB-butyl and 2,4-DB-isoctyl.

Suitable salts of dichlorprop are for example dichlorprop-sodium, dichlorprop-potassium and dichlorprop-dimethylammonium. Examples of suitable esters of dichlorprop are dichlorprop-butotyl and dichlorprop-isoctyl.

Suitable salts and esters of MCPA include MCPA-butotyl, MCPA-butyl, MCPA-dimethylammonium, MCPA-diolamine, MCPA-ethyl, MCPA-thioethyl, MCPA-2-ethylhexyl, MCPA-isobutyl, MCPA-isoctyl, MCPA-isopropyl, MCPA-isopropylammonium, MCPA-methyl, MCPA-olamine, MCPA-potassium, MCPA-sodium and MCPA-trolamine.

A suitable salt of MCPB is MCPB sodium. A suitable ester of MCPB is MCPB-ethyl.

Suitable salts of clopyralid are clopyralid-potassium, clopyralid-olamine and clopyralid-tris-(2-hydroxypropyl)ammonium. Example of suitable esters of clopyralid is clopyralid-methyl.

Examples of a suitable ester of fluroxypyr are fluroxypyr-meptyl and fluroxypyr-2-butoxy-1-methylethyl, wherein fluroxypyr-meptyl is preferred.

Suitable salts of picloram are picloram-dimethylammonium, picloram-potassium, picloram-triisopropanolammonium, picloram-triisopropylammonium and picloram-trolamine. A suitable ester of picloram is picloram-isoctyl.

A suitable salt of triclopyr is triclopyr-triethylammonium. Suitable esters of triclopyr are for example triclopyr-ethyl and triclopyr-butotyl.

Suitable salts and esters of chloramben include chloramben-ammonium, chloramben-diolamine, chloramben-methyl, chloramben-methylammonium and chloramben-sodium. Suitable salts and esters of 2,3,6-TBA include 2,3,6-TBA-dimethylammonium, 2,3,6-TBA-lithium, 2,3,6-TBA-potassium and 2,3,6-TBA-sodium.

Suitable salts and esters of aminopyralid include aminopyralid-potassium, aminopyralid-dimethylammonium, and aminopyralid-tris(2-hydroxypropyl)ammonium.

Suitable salts of glyphosate are for example glyphosate-ammonium, glyphosate-diammonium, glyphoste-dimethylammonium, glyphosate-isopropylammonium, glyphosate-potassium, glyphosate-sodium, glyphosate-trimesium as well as the ethanolamine and diethanolamine salts, preferably glyphosate-diammonium, glyphosate-isopropylammonium and glyphosate-trimesium (sulfosate).

A suitable salt of glufosinate is for example glufosinate-ammonium.

A suitable salt of glufosinate-P is for example glufosinate-P-ammonium.

Suitable salts and esters of bromoxynil are for example bromoxynil-butyrate, bromoxynil-heptanoate, bromoxynil-octanoate, bromoxynil-potassium and bromoxynil-sodium.

Suitable salts and esters of ioxonil are for example ioxonil-octanoate, ioxonil-potassium and ioxonil-sodium.

Suitable salts and esters of mecoprop include mecoprop-butotyl, mecoprop-dimethylammonium, mecoprop-diolamine, mecoprop-ethadyl, mecoprop-2-ethylhexyl, mecoprop-isoctyl, mecoprop-methyl, mecoprop-potassium, mecoprop-sodium and mecoprop-trolamine.

Suitable salts of mecoprop-P are for example mecoprop-P-butotyl, mecoprop-P-dimethylammonium, mecoprop-P-2-ethylhexyl, mecoprop-P-isobutyl, mecoprop-P-potassium and mecoprop-P-sodium.

A suitable salt of diflufenzopyr is for example diflufenzopyr-sodium.

A suitable salt of naptalam is for example naptalam-sodium.

Suitable salts and esters of aminocyclopyrachlor are for example aminocyclopyrachlor-dimethylammonium, aminocyclopyrachlor-methyl, aminocyclopyrachlor-triisopropanolammonium, aminocyclopyrachlor-sodium and aminocyclopyrachlor-potassium.

A suitable salt of quinclorac is for example quinclorac-dimethylammonium.

A suitable salt of quinmerac is for example quinmerac-dimethylammonium.

A suitable salt of imazamox is for example imazamox-ammonium.

Suitable salts of imazapic are for example imazapic-ammonium and imazapic-isopropylammonium.

Suitable salts of imazapyr are for example imazapyr-ammonium and imazapyr-isopropylammonium.

A suitable salt of imazaquin is for example imazaquin-ammonium.

Suitable salts of imazethapyr are for example imazethapyr-ammonium and imazethapyr-isopropylammonium.

A suitable salt of topramezone is for example topramezone-sodium.

In the method of this invention, the weight ratio of the herbicide A (as defined herein) to herbicide B is generally in the range of from 1:1000 to 1000:1, preferably in the range of from 1:500 to 500:1, in particular in the range of from 1:250 to 250:1 and particularly preferably in the range of from 1:75 to 75:1, wherein each herbicide B being an ester or a salt of an acid is calculated as the acid.

In the method of this invention, the weight ratio of the herbicide A (as defined herein) to safener C is generally in the range of from 1:1000 to 1000:1, preferably in the range of from 1:500 to 500:1, in particular in the range of from 1:250 to 250:1 and particularly preferably in the range of from 1:75 to 75:1, wherein each safener C being an ester or a salt of an acid is calculated as the acid.

In the method of this invention, the weight ratio of herbicide B to safener C is generally in the range of from 1:1000 to 1000:1, preferably in the range of from 1:500 to 500:1, in particular in the range of from 1:250 to 250:1 and particularly preferably in the range of from 1:75 to 75:1, wherein each herbicide B and safener C being an ester or a salt of an acid is calculated as the acid.

In the method of this invention, the weight ratio of the combination of the herbicide A (as defined herein) and the herbicide B to the safener C is preferably in the range of from 1:500 to 500:1, in particular in the range of from 1:250 to 250:1 and particularly preferably in the range of from 1:75 to 75:1, wherein each herbicide B and safener C being an ester or a salt of an acid is calculated as the acid.

In the method of this invention, the application rate of the herbicide B (in case of salts calculated as the acid) is generally from 0.0005 kg/ha to 10 kg/ha, preferably from 0.005 kg/ha to 5 kg/ha and more preferably from 0.001 kg/ha to 2 kg/ha.

In the method of this invention, the application rate of the safener C (in case of salts calculated as the acid) is generally from 0.0005 kg/ha to 2.5 kg/ha, preferably from 0.005 kg/ha to 2 kg/ha and more preferably from 0.01 kg/ha to 1.5 kg/ha.

In the method of the invention, the herbicide A (as defined herein) and, if present, the herbicide B and/or the safener C can be applied jointly or separately.

In the method of the invention, the herbicide A (as defined herein) and, if present, the herbicide B and/or the safener C can be applied simultaneously or in succession.

Preferably, the herbicide A (as defined herein) and, if present, the herbicide B and/or the safener C are applied simultaneously to the undesirable vegetation. In another embodiment, the herbicide A (as defined herein) and, if present, the herbicide B and/or the safener C are provided as herbicidal composition as defined herein (e.g. a tank mixture containing the herbicide A (as defined herein) and, if present, the herbicide B and/or the safener C) being applied to aquatic environment.

In case of separate or successive application, the order of the application of the herbicide A (as defined herein) and, if present, the herbicide B and/or the safener C is of minor importance. It is only necessary that the herbicide A (as defined herein) and, if present, the herbicide B and/or the safener C are applied in a time frame that allows simultaneous action of the active ingredients on the undesirable vegetation to be controlled and/or safened, preferably within a time frame of at most 14 days, in particular at most 7 days.

The following examples serve to illustrate the invention.

### EXAMPLES

### 1. General Procedure

Certain formulations of a herbicide A are examined at various rates and timings for weed control, crop injury and rice grain yield on a water-seeded rice system. The following experiments are conducted at the Rice Experiment Station in Biggs, California, USA in a silty clay soil. They are conducted as a randomized complete block design with three replications. The plot size is 10 feet (3.048 m) by 20 feet (6.096 m) with individual levees around each plot to prevent contamination of herbicide from plot to plot.

Suitable formulations of the herbicide A may include e.g., emulsifiable concentrates (EC), capsule suspensions (CS), granules (GR) or suspension concentrates (SC).

Each formulation of the herbicide A may be applied at a certain application rate (in kg ai/ha) at e.g., 5, 10 and/or 15 days after seeding (DAS).

M-206 rice is seeded at a rate of 120 lbs/A (134.5 kg/ha) in the month of May by airplane and is harvested for grain in the month of October of the same year. This seeding rate which is below the normal rate at the grower fields (170-200 lb/A equivalent to 190.54-224.17 kg/ha) is used to allow more weed infestation in the field. The water is brought in the field a day before seeding and kept at a water depth of 4 inch (10.16 cm) throughout the growing season. The water is shut off a month before harvesting.

The CS, EC and/or SC formulations of the herbicide A are applied e.g., at 20 gallons/A (187.08 I/ha) with a 10 feet (3.048 m) two-man boom sprayer with a C02 backpack at 30 psi (2.07 bar) with flat-fan 8003 nozzles at 3 miles per hour (4.83 km/h) sprayed into the water. The GR formulation of the herbicide A is spread by hand in each respective plot.

Visual percent ratings for rice injury is collected as chlorosis, stunting, bleaching and stand reduction at 40 days after treatment (DAT). Rice stand and tiller count per square feet (0.0929 m²) was collected 75 DAS. Plant height is recorded at 108 DAS. Visual percent ratings for weed control may be recorded at 14, 24 or 56 DAT for individual weeds present which include, inter alia, Echinochloa spp., e.g. Echinochloa crus-galli (ECHCG, common barnyard grass) and Echinochloa oryzicola (ECHCR, late watergrass) and Leptochloa fusca, e.g. Leptochloa fusca subsp. fascicularis (LEFFA, bearded sprangletop) as the most important grass weeds but also sedges and broadleaf weeds such as, for example, Cyperus difformis (CYPDI, small-flower umbrella sedge), Ammannia auriculata (AMMAU, redstem), Bacopa monnieri (BAOMO, Monnier water hyssop), Heteranthera limosa (HETLI, duck salad) and Schoenoplectiella mucronata (SCPMU, rice-field bulrush). The untreated plots are used as the base or zero for visual percent ratings for both rice injury and weed control. Rice yield is determined at 14% moisture. An area of 21 square feet (1.951 m²) of rice is cut from the center of each plot and then to separate the seed from the stalk a thresher is used. The seeds are cleaned and the moisture is obtained and then weighed to determine yield. Data is analyzed with analyses of variance (ANOVA) and least significance difference (LSD) test (significance level p=0.05) using ARM software (GDM Solutions, Inc. 2020).

2. Field Trials with Saflufenacil as Herbicide A

Saflufenacil formulations as detailed below were examined for weed control and crop injury on a water-seeded rice system. The following experiments were conducted at the Rice Experiment Station in Biggs, California, USA in a silty clay soil. They were conducted as a randomized complete block design with three replications. The plot size was 10 feet (3.048 m) by 20 feet (6.096 m) with individual levees around each plot to prevent contamination of herbicide from plot to plot.

Saflufenacil was applied in two formulations, namely Sharpen®, a suspension concentrate (SC) formulation available from BASF Corporation and containing 29.74% of saflufenacil, and a CS formulation having an active ingredient concentration of 130 g/l.

Each formulation of saflufenacil was applied at rates of 0.05 and 0.1 kg/ha at 10 days after seeding (DAS).

M-206 rice was seeded at a rate of 120 lbs/A (134.5 kg/ha) in the month of May by airplane and is harvested for grain in the month of October of the year 2021. This seeding rate which was below the normal rate at the grower fields (170-200 lb/A equivalent to 190.54-224.17 kg/ha) was used to allow more weed infestation in the field. The water was brought in the field a day before seeding and kept at a water depth of 4 inch (10.16 cm) throughout the growing season. The water was shut off a month before harvesting.

The CS and SC formulations of saflufenacil were applied at 20 gallons/A (187.08 I/ha) with a 10 feet (3.048 m) two-man boom sprayer with a C02 backpack at 30 psi (2.07 bar) with flat-fan 8003 nozzles at 3 miles per hour (4.83 km/h) sprayed into the water.

Visual percent ratings for rice injury were collected as stand reduction at 40 days after treatment (DAT). Rice stand and tiller count per square feet (0.0929 m²) was collected 75 DAS. Plant height is recorded at 108 DAS. Visual percent ratings for weed control were recorded at 56 DAT for individual weeds (see Table 1 below). The untreated plots were used as the base or zero for visual percent ratings for both rice injury and weed control. Data is analyzed with analyses of variance (ANOVA) and least significance difference (LSD) test (significance level p=0.05) using ARM software (GDM Solutions, Inc. 2020).
Table 1: Weed control ratings at 56 DAT and stand reduction ratings at 40 DAT by treatment with two formulations of saflufenacil; Abbreviations: SC=SC formulation, i.e. Sharpen®, CS=CS formulation containing 130 g ai/1, g ai/l=grams of active ingredient per liter, kg ai/ha=kilograms of active ingredient per hectare, DAS=days after seeding, DAT=days after treatment, ECHCG=Echinochloa crus-galli (common barnyard grass), SCPMU=Schoenoplectiella mucronata (rice-field bulrush), CYPDI=Cyperus difformis (small-flower umbrella sedge), BAOMO: Bacopa monnieri (Monnier water hyssop), HETLI: Heteranthera limosa (duck salad), AMMAU: Ammannia auriculata (redstem)

| | | | Weed control (%) by species | | | | | | % Stand |
|---|---|---|---|---|---|---|---|---|---|
| | Rate | | at 56 DAT | | | | | | Reduction at |
| Treatment | (kg ai/ha) | Timing | ECHCG | SCPMU | CYPDI | BAOMO | HETLI | AMMAU | 40 DAT |
| Untreated | — | — | 0 | 0 | 0 | 0 | 0 | 0 | 0 |
| SC | 0.05 | 10 DAS | 18 | 81 | 85 | 100 | 100 | 87 | 20 |
| SC | 0.1 | 10 DAS | 41 | 89 | 92 | 100 | 99 | 94 | 3 |
| CS | 0.05 | 10 DAS | 3 | 84 | 86 | 100 | 99 | 93 | 9 |
| CS | 0.1 | 10 DAS | 21 | 84 | 86 | 100 | 98 | 97 | 2 |

As can be seen from the Table 1 above, the SC and CS formulations of saflufenacil (herbicide A) were found to be suitable for combined efficacious weed control and crop safety when applied in flooded rice fields in a pre- or early post-emergence treatment and after germination of the rice seedlings.

1. A method for controlling undesirable vegetation in an aquatic environment in which a rice plant is growing, said method comprising applying to the aquatic environment an herbicidally effective amount of an herbicide A pre-emergence or early post-emergence of the undesirable vegetation and after germination of the rice seedlings, wherein the herbicide A is selected from the group consisting of acetochlor, acifluorfen, alachlor, aminopyralid, bensulfuron, benzobicyclon, bicyclopyrone, bispyribac, butylate, carfentrazone, chlorimuron, chlorsulfuron, cinmethylin, clethodim, clodinafop, clomazone, clopyralid, cycloate, cyhalofop, 2,4-D, dicamba, diflufenzopyr, dimethenamid, dimethenamid-P, dithiopyr, EPTC, ethalfluralin, ethofumesate, fenoxaprop, fenoxaprop-P, florpyrauxifen, fluazifop, fluazifop-P, flufenacet, flumiclorac, flumioxazin, fluroxypyr, fluthiacet, fomesafen, halauxifen, halosulfuron, iodosulfuron, imazamox, imazapic, imazapyr, imazaquin, imazethapyr, isoxaflutole, lactofen, MCPA, mesosulfuron, mesotrione, metolachlor, S-metolachlor, metsulfuron, MSMA, nicosulfuron, orthosulfamuron, penoxsulam, pinoxaden, primisulfuron, propanil, propyzamide, pyrasulfotole, pyrithiobac, pyroxasulfone, pyroxulam, quinclorac, quizalofop, quizalofop-P, rimsulfuron, saflufenacil, sethoxydim, sulfentrazone, sulfosulfuron, tembotrione, tetflupyrolimet, thifensulfuron, thiobencarb, tiafenacil, tolpyralate, topramezone, triallate, triasulfuron, tribenuron, triclopyr, trifloxysulfuron, trifludimoxazin, trifluralin, triflusulfuron, and agriculturally acceptable salts or derivatives thereof.

2. The method according to claim 1 wherein the herbicide A is applied into the water or onto the water surface of the aquatic environment.

3. The method according to claim 1 wherein the aquatic environment is a flooded rice field, a flooded rice paddy, a pond, a tank, or a lake.

4. The method according to claim 1 wherein an herbicidally effective amount of a composition comprising the herbicide A is applied.

5. The method according to claim 1 wherein the herbicide A is selected from the group consisting of bensulfuron, benzobicyclon, bispyribac, carfentrazone, cinmethylin, clomazone, cyhalofop, dimethenamid, dimethenamid-P, halosulfuron, metolachlor, S-metolachlor, orthosulfamuron, penoxsulam, propanil, pyroxasulfone, saflufenacil, thiobencarb, triclopyr, and agriculturally acceptable salts or esters thereof.

6. The method according to claim 1 wherein the herbicide A is selected from the group consisting of bensulfuron, bensulfuron-methyl, benzobicyclon, bispyribac, bispyribac-sodium, carfentrazone, carfentrazone-ethyl, cinmethylin, clomazone, cyhalofop, cyhalofop-butyl, dimethenamid, dimethenamid-P, halosulfuron, halosulfuron-methyl, metolachlor, S-metolachlor, orthosulfamuron, penoxsulam, propanil, pyroxasulfone, saflufenacil, thiobencarb, triclopyr, triclopyr-triethylammonium, triclopyr-ethyl, triclopyr-butotyl, and triclopyr-choline.

7. The method according to claim 1 wherein the herbicide A is selected from the group consisting of clomazone, dimethenamid-P, metolachlor, S-metolachlor, pyroxasulfone and saflufenacil, more preferably selected from clomazone, metolachlor, S-metolachlor, and saflufenacil.

8. The method according to claim 4 wherein the herbicide A is present in the composition in the form of liquid droplets, microcapsules, or solid particles.

9. The method according to claim 4 wherein the composition is a liquid or solid formulation, each optionally diluted with water.

10. The method according to claim 4 wherein the composition is an emulsifiable concentrate (EC) comprising the herbicide A being diluted with water, a suspension concentrate (SC) comprising the herbicide A being diluted with water, a capsule suspension (CS) comprising the herbicide A being optionally diluted with water, or granules (GR) comprising the herbicide A.

11. The method according to claim 4 wherein the composition is a suspension concentrate (SC) comprising the herbicide A being diluted with water, a capsule suspension (CS) comprising the herbicide A or a dilute aqueous suspension obtained from diluting the capsule suspension (CS) with water.

12. The method according to claim 4 wherein the composition is a capsule suspension (CS) comprising the herbicide A or a dilute aqueous suspension obtained from diluting the capsule suspension (CS) with water.

13. The method according to claim 10 wherein a D₅₀ of capsules in the capsule suspension (CS) or the dilute aqueous suspension is in the range of from 1 to 100 μm.

14. The method according to claim 1 wherein the rice plant is selected from the group consisting of flooded dry-seeded, drill-seeded, wet-seeded, water-seeded, and transplanted rice.

15. The method according to claim 1 wherein the herbicide A is applied shortly before or shortly after emergence of the undesirable vegetation.

16. The method according to claim 1 wherein the herbicide A is applied from the 2-leaf to the 6-leaf growth stage of the rice seedlings (BBCH Code 12 to 16).

17. The method according to claim 1 wherein the herbicide A is applied at a rate of 0.0001 to 10 kilograms of active ingredient per hectare (kg ai/ha) to 7 kg ai/ha.

18. The method according to claim 1 wherein saflufenacil is applied at a rate of 0.01 to 0.5 kilograms of active ingredient per hectare (kg ai/ha).

19. The method according to claim 1 wherein the herbicide A is applied from 5 to 15 days after the rice seeds have been sown or after the rice plants have been transplanted.

20. The method according to claim 1 wherein the undesirable vegetation comprises an herbicide resistant or tolerant weed species.

21. The method according to claim 20 wherein the herbicide resistant or tolerant weed species is a biotype with resistance or tolerance to at least one herbicide selected from the group consisting of acetyl CoA carboxylase (ACCase) inhibitors (HRAC Group A), acetolactate synthase (ALS) inhibitors (HRAC Group B), photosystem II (PS II) inhibitors (HRAC Groups C1, C2 and C3), DOXP synthase inhibitors (HRAC Group F4), and very long chain fatty acid (VLCFA) inhibitors (HRAC Group K3).

22. The method according to claim 1 wherein the undesirable vegetation is selected from the group consisting of the genera Aegilops, Avena, Brachiaria, Bromus, Cenchrus, Chloris, Cyperus, Dactyloctenium, Digitaria, Echinochloa, Eleusine, Eriochloa, Leptochloa, Lolium, Panicum, Phalaris, Poa, Rottboellia, Setaria, Sorghum, Urochloa, Abutilon, Amaranthus, Ammannia, Amsinckia, Anchusa, Bacopa, Barbarea, Bassia, Brassica, Calandrinia, Capsella, Chamaesyce, Chenopodium, Cuscuta, Erodium, Heteranthera, Ipomoea, Lactuca, Lamium, Mollugo, Persicaria, Polygonum, Pontederia, Portulaca, Richardia, Schoenoplectiella, Senecio, Sida, Sinapis, Sisymbrium, Solanum, Stellaria and Tribulus, more preferably selected from the genera Cyperus, Echinochloa, Leptochloa, Ammannia, Bacopa, Heteranthera, and Schoenoplectiella.

23. The method according to claim 1 wherein the undesirable vegetation is selected from the group consisting of Aegilops cylindrical (AEGCY, jointed goatgrass), Avena fatua (AVEFA, wild oat), Brachiaria platyphylla (BRAPP, broadleaf signalgrass), Brachiaria texana (PANTA, Texas panicum), Bromus commutato (BROCO, hairy chess), Bromus japonicus (BROJA, Japanese brome), Bromus secalinus (BROSE, cheat), Bromus tectorum (BROTE, downy brome), Cenchrus spinifex (CCHPA, field sandbur), Chloris barbata (CHRBA, swollen fingergrass), Cyperus difformis (CYPDI, small-flower umbrella sedge), Cyperus eragrostis (CYPER, lovegrass sedge), Dactyloctenium aegyptium (DTTAE, crowfoot grass), Digitaria sanguinalis (DIGSA, large crabgrass), Echinochloa colonum (ECHCO, jungle rice), Echinochloa crus-galli (ECHCG, common barnyard grass), Echinochloa muricata (ECHPU, prickly barnyardgrass), Echinochloa muricata var. microstachya (ECHCM, rough barnyardgrass), Echinochloa oryzicola (ECHCR, late watergrass), Echinochloa oryzoides (ECHOR, early watergrass), Echinochloa walteri (ECHWA, water millet), Eleusine indica (ELEIN, goosegrass), Eriochloa villosa (ERBVI, woolly cupgrass), Leptochloa fusca subsp. uninervia (LEFUN, Mexican sprangletop), Leptochloa fusca subsp. fascicularis (LEFFA, bearded sprangletop), Lolium multiflorum (LOLMU, Italian ryegrass), Lolium rigidum (LOLRI, annual ryegrass), Panicum capillare (PANCA, witchgrass), Panicum dichotomiflorum (PANDI, fall panicum), Panicum miliaceum (PANMI, wild proso millet), Phalaris canariensis (PHACA, canarygrass), Poa annua (POAAN, annual bluegrass), Rottboellia cochinchinensis (ROOEX, itch grass), Setaria faberi (SETFA, giant foxtail), Setaria pumila (SETPU, yellow foxtail), Setaria viridis (SETVI, green foxtail), Sorghum halepense (SORHA, Johnson grass), Sorghum×drummondii (SORSU, shattercane), Urochloa fusca (PANFA, browntop panicum), Urochloa maxima (PANMA, guineagrass), Abutilon theophrasti (ABUTH, velvet leaf), Amaranthus palmeri (AMAPA, Palmer amaranth), Amaranthus retroflexus (AMARE, pigweed), Amaranthus tuberculatus (AMATU, tall waterhemp), Ammannia auriculata (AMMAU, redstem), Ammannia coccinea (AMMCO, purple redstem), Amsinckia menziesii (ANSME, fiddleneck), Anchusa arvensis (LYCAR, small bugloss), Bacopa monnieri (BAOMO, Monnier water hyssop), Barbarea vulgaris (BARVU, bittercress), Bassia scoparia (KCHSC, kochia), Brassica nigra (BRSNI, black mustard), Calandrinia ciliata subsp. menziesii (CLNCM, redmaids rock purslane), Capsella bursa-pastoris (CAPBP, shepherd's purse), Chamaesyce maculata (EPHMA, annual spurge), Chenopodium album (CHEAL, common lambsquarters), Chenopodium leptophyllum (CHELE, slimleaf lambsquarters), Cuscuta europaea (CVCAU, large dodder), Erodium cicutarium (EROCI, redstem filaree), Heteranthera limosa (HETLI, duck salad), Ipomoea hederacea (IPOHE, morningglory), Lactuca serriola (LACSE, prickly lettuce), Lamium amplexicaule (LAMAM, henbit), Mollugo verticillata (MOLVE, carpetweed), Persicaria maculosa (POLPE, ladysthumb), Persicaria pensylvanica (POLPY, Pennsylvania smartweed), Polygonum aviculare (POLAV, prostrate knotweed), Pontederia vaginalis (MOOVA, monochoria), Portulaca oleracea (POROL, purslane), Richardia scabra (RCHSC, Florida pusley), Schoenoplectiella mucronata (SCPMU, rice-field bulrush), Senecio vulgaris (SENVU, common groundsel), Sida spinosa (SIDSP, prickly sida), Sinapis arvensis (SINAR, wild mustard), Sisymbrium irio (SSYIR, London rocket), Solanum nigrum (SOLNI, black nightshade), Stellaria media (STEME, common chickweed), and Tribulus terrestris (TRBTE, common puncturevine).

24. The method according to claim 1 wherein the herbicide A is applied in combination with at least one further herbicide B selected from the groups b1) to b15)
b1) lipid biosynthesis inhibitors;
b2) acetolactate synthase inhibitors (ALS inhibitors);
b3) photosynthesis inhibitors;
b4) protoporphyrinogen-IX oxidase inhibitors,
b5) bleacher herbicides;
b6) enolpyruvyl shikimate 3-phosphate synthase inhibitors (EPSP inhibitors);
b7) glutamine synthetase inhibitors;
b8) 7,8-dihydropteroate synthase inhibitors (DHP inhibitors);
b9) mitosis inhibitors;
b10) inhibitors of the synthesis of very long chain fatty acids (VLCFA inhibitors);
b11) cellulose biosynthesis inhibitors;
b12) decoupler herbicides;
b13) auxinic herbicides;
b14) auxin transport inhibitors; and
b15) other herbicides selected from the group consisting of bromobutide, chlorflurenol, chlorflurenol-methyl, cumyluron, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, indaziflam, maleic hydrazide, mefluidide, metam, methiozolin, methyl azide, methyl bromide, methyl-dymron, methyl iodide, oleic acid, oxaziclomefone, pelargonic acid, pyributicarb, quinoclamine, triaziflam, tridiphane, and 6-chloro-3-(2-cyclopropyl-6-methylphenoxy)-4-pyridazinol (CAS 499223-49-3) and its salts and esters;
and agriculturally acceptable salts or derivatives thereof.

25. The method according to claim 1 wherein the herbicide A is applied in combination with at least one safener C selected from the group consisting of benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthaleneacetic acid (NAA), naphthalic anhydride (NA), oxabetrinil, 4-(dichloroacetyl)-1-oxa-4-azaspiro[4.5]decane (MON4660, CAS 71526-07-3), 2,2,5-trimethyl-3-(dichloroacetyl)-1,3-oxazolidine (R-29148, CAS 52836-31-4), metcamifen, 4-bromophenyl chloromethyl sulfone (BPCMS, CAS 54091-06-4), and agriculturally acceptable salts or derivatives thereof.

26. The method according to claim 7 wherein the herbicide A is saflufenacil.
